(19) United States
(12) Patent Application Publication
(10) Pub. No.: US 2020/0205156 A1
(43) Pub. Date: Jun. 25, 2020

(54) LTE COEXISTENCE WITH 5G NR

(71) Applicant: CONVIDA WIRELESS, LLC, Wilmington, DE (US)

(72) Inventors: Pascal M. ADJAKPLE, Great Neck, NY (US); Qing LI, Princeton Junction, NJ (US); Joseph M. MURRAY, Schwenksville, PA (US); Guodong ZHANG, Woodbury, NY (US); Lakshmi R. IYER, King of Prussia, PA (US)

(21) Appl. No.: 16/622,359

(22) PCT Filed: Jun. 26, 2018
(86) PCT No.: PCT/US2018/039503

§ 371 Date: Dec. 13, 2019

Related U.S. Application Data
(60) Provisional application No. 62/604,178, filed on Jun. 26, 2017.

(51) Int. Cl. H04W 72/04; H04W 72/08; H04W 74/08; H04W 52/36; H04W 72/10

(52) U.S. Cl. CPC H04W 72/0453; H04W 72/085; H04W 72/10; H04W 52/365; H04W 74/0833

(57) ABSTRACT

Portions of LTE time-frequency resources may need to be configured and signaled while NR resources may need to be addressed when LTE and NR share the same carrier on Uplink (UL), Downlink (DL), or both. Further, a UE may need to select a UL carrier frequency. A UL carrier may need to be selected in order to perform NR operation in idle mode, Radio Resource Control (RRC) Inactive mode, or RRC Connected mode. Multi-connectivity across multiple RATs when a UE is capable of operating simultaneously on more than one RAT, e.g., NR and LTE, NR and WLAN, and/or NR, LTE and WLAN, is also described herein.

### CROSS-REFERENCE TO RELATED APPLICATION

This application claims the benefit of priority of U.S. Provisional Application No. 62/604,178 filed Jun. 26, 2017 which is incorporated herein in its entirety by reference.

### BACKGROUND

The disclosure pertains to the coexistence of LTE and WLAN networks with NR networks, e.g., 5G deployments.

### SUMMARY

LTE and WLAN networks are widely deployed and are expected to co-exist with 5G networks for many years after 5G deployment. Operators are likely to resort to LTE frequency spectrum refarming as a cost effective way to redeploy existing spectrum for NR while providing service to legacy LTE UEs. As a result, portions of LTE time-frequency resources may need to be configured and signaled while NR resources may need to be addressed when both LTE and NR share the same carrier on UL, DL, or both. Further, a UE may need to select a UL carrier frequency. A carrier frequency may be shared by another Radio Access Technology (RAT) (e.g., LTE or WLAN). As a result, a UL carrier may need to be selected in order to perform NR operation in idle mode, Radio Resource Control (RRC) Inactive mode, or RRC Connected mode. Another problem described herein is the problem of multi-connectivity across multiple RATs when a UE is capable of operating simultaneously on more than one RAT, e.g., NR and LTE, NR and WLAN, and/or NR, LTE and WLAN.

Embodiments may comprise a UE receiving system information from a gNB, the system information comprising first NR resource configuration, establishing an RRC connection with the gNB, and receiving second NR resource configuration through dedicated RRC signaling.

Embodiments for selecting a carrier may comprise selecting a highest priority first UL carrier frequency, setting a variable to the selected carrier frequency, performing measurements on the variable, and estimating a path loss on the variable. If the estimated path loss is less than a maximum path loss, the UE may set the first UL carrier frequency as the carrier for UL operations. If the estimated path loss is not less than a maximum path loss, the UE may select a next highest priority carrier frequency and set the variable to the selected carrier frequency. Alternative, the UE may select the carrier frequency with the least path loss.

Embodiments for selecting a carrier may comprise selecting a highest priority first UL carrier frequency, setting a variable to the selected carrier frequency, performing measurements on the variable, and estimating a PRACH transmit power of the variable. If the PRACH transmit power is less than a maximum PRACH transmit power, the UE may set the first UL carrier frequency as the carrier for UL operations. If the PRACH transmit power is not less than a maximum PRACH transmit power, the UE may select a next highest priority carrier frequency and set the variable to the selected carrier frequency. Alternative, the UE may select the carrier frequency with the least PRACH transmit power.

Embodiments for selecting a carrier may comprise selecting a highest priority first UL carrier frequency, setting a variable to the selected carrier frequency, performing measurements on the variable, and estimating a power headroom of the variable. If the power headroom is greater than a minimum power headroom, the UE may set the first UL carrier frequency as the carrier for UL operations. If the power headroom is not greater than a minimum power headroom, the UE may select a next highest priority carrier frequency and set the variable to the selected carrier frequency. Alternative, the UE may select the carrier frequency with the largest power headroom.

Embodiments for selecting a carrier may comprise selecting a highest priority first UL carrier frequency, setting a variable to the selected carrier frequency, performing measurements on the variable, and estimating a quality of the variable. If the quality meets a specified quality criteria, the UE may set the first UL carrier frequency as the carrier for UL operations. If the quality does not meet the specified quality criteria, the UE may select a next highest priority carrier frequency and set the variable to the selected carrier frequency. Alternative, the UE may select the carrier frequency with the highest quality.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with accompanying drawings.

FIG. 1 illustrates an example of NR and LTE coexistence in MBSFN subframes in the same carrier.

FIG. 2 illustrates an example of NR and LTE co-existence in non-MBSFN subframes in the same carrier.

FIGS. 3A and 3B depict an example deployment of NR and LTE.

FIGS. 4A and 4B illustrate an example of NR coexistence with LTE on a cell.

FIG. 5 illustrates two example scenarios for LTE and NR coexistence.

FIG. 6 illustrates three examples of UL resource sharing in a frequency domain between NR and LTE.

FIG. 7 illustrates two example types of UEs.

FIG. 8 illustrates that a UE may need to decide on UL carrier selection or carrier aggregation for simultaneous UL transmission.

FIG. 9 illustrates the principles of subframe allocation period, subframe allocation period repetition, and subframe allocation modification period.

FIGS. 10A and 10B illustrate an example configuration where the network may assign resource grants to legacy UEs within MBSFN subframes configured for NR operation;

FIGS. 11A and 11B illustrates an example configuration scenario where only NR UEs are assigned resource grants in the MBSFN subframe configured for NR.

FIGS. 12A and 12B illustrate another example of MBSFN subframe configurations as NR subframes where the SFA period is multiple LTE radio frames long.

FIGS. 13A and 13B illustrate another example of MBSFN subframe configurations as NR subframes where the SFA period is multiple LTE radio frames long.

FIGS. 14A and 14B illustrate an example of an NR subframe configuration using non-MBSFN subframes where the NR subframe allocation (SFA) period is one LTE radio frame (10 subframes) long.

FIGS. 15A and 15B illustrate an example of non-MBSFN subframe configurations as NR subframes where the SFA period is multiple LTE radio frames long.

FIGS. 16A-16D illustrate an example of mini-slot level configuration in MBSFN subframes of NR resources (in downlink) in case of co-existence with LTE.

FIGS. 17A-17H illustrate another example of mini-slot level configuration in MBSFN subframes of NR resources (in downlink) in case of co-existence with LTE.

FIGS. 18A-18D illustrate another example of mini-slot level configuration in MBSFN subframes of NR resources (in downlink) in case of co-existence with LTE.

FIGS. 19A-19D illustrate another example of mini-slot level configuration in MBSFN subframes of NR resources (in downlink) in case of co-existence with LTE.

FIGS. 20A-20H illustrate another example of mini-slot level configuration in non-MBSFN subframes of NR resources (in downlink) in case of co-existence with LTE.

FIGS. 21A-21D illustrate another example of mini-slot level configuration in non-MBSFN subframes of NR resources (in downlink) in case of co-existence with LTE.

FIGS. 22A-22D illustrate another example of mini-slot level configuration in non-MBSFN subframes of NR resources (in downlink) in case of co-existence with LTE.

FIG. 23 illustrates configuration parameters in frequency domain.

FIGS. 24A-24B illustrate a conceptual signaling flow for NR resource configuration.

FIG. 25 illustrates an exemplary embodiment of NR resource configuration through common PDCCH with whose resource location is signaled in system information broadcast.

FIG. 26 an exemplary embodiment of NR resources configuration through system information broadcast.

FIG. 27 illustrates UL carrier selection based on absolute priority, using a path-loss based selection.

FIG. 28 illustrates UL carrier selection based on absolute priority, using a PRACH transmit power based selection.

FIG. 29 illustrates UL carrier selection based on absolute priority, using a power head room based selection.

FIG. 30 illustrates UL carrier selection based on absolute priority, using a UL Srxlev and UL Squal based selection.

FIG. 31 illustrates a MAC level UL Multi-RAT carrier aggregation model from a UE perspective.

FIG. 32 illustrates a MAC level UL Multi-RAT carrier aggregation model from a gNB perspective.

FIG. 33A illustrates one embodiment of an example communications system in which the methods and apparatuses described and claimed herein may be embodied.

FIG. 33B is a block diagram of an example apparatus or device configured for wireless communications in accordance with the embodiments illustrated herein.

FIG. 33C is a system diagram of an example radio access network (RAN) and core network in accordance with an example embodiment.

FIG. 33D is another system diagram of a RAN and core network according to another embodiment.

FIG. 33E is another system diagram of a RAN and core network according to another embodiment.

FIG. 33F is a block diagram of an exemplary computing system 90 in which one or more apparatuses of the communications networks illustrated in FIGS. 33A, 33C, 33D and 33E may be embodied.

### DETAILED DESCRIPTION

International Mobile Telecommunications (IMT) for 2020 and beyond (e.g., IMT 2020) is envisaged to expand and support diverse families of usage scenarios and applications that will continue beyond the current IMT. Furthermore, a broad variety of capabilities may be tightly coupled with these different usage scenarios. Example families of usage scenarios include enhanced Mobile Broadband (eMBB), Ultra-Reliable and Low Latency Communications (URLLC), and massive Machine Type Communications (mMTC). These usage scenarios may have diverse and conflicting service requirements with regard to latency, data rates, mobility, device diversity, reliability, UE battery life, network energy consumption, and other characteristics. In light of these diverse and conflicting service requirements that the next generation international mobile telecommunication system must support, 3GPP has identified a set of system architecture requirements.

Example operating characteristics of next generation architecture requirements may include the following:

The RAN architecture shall support tight interworking between the new RAT and LTE. The RAN may have high performing inter-RAT mobility and aggregation of data flows via at least dual connectivity between LTE and new RAT. Such a requirement may be supported for both collocated and non-collocated site deployments;

The CN architecture and the RAN architecture shall allow for C-plane/U-plane separation;

The RAN architecture shall support connectivity through multiple transmission points, either collocated or non-collocated;

The RAN architecture shall enable a separation of control plane signalling and user plane data from different sites;

The RAN architecture shall support interfaces supporting effective inter-site scheduling coordination;

Different options and flexibility for splitting the RAN architecture shall be allowed. The RAN architecture shall allow deployments using Network Function Virtualization;

The CN architecture and the RAN architecture shall allow for the operation of Network Slicing;

Support services that have different latency requirements between the UE and the Data Network;

Support multiple simultaneous connections of an UE via multiple access technologies;

Support transmission of IP packets, non-IP PDUs and Ethernet frames;

Support network sharing; and

Allow independent evolutions of core network and RAN, and minimize access dependencies.

LTE and WLAN networks are widely deployed and are expected to co-exist with 5G networks for many years after 5G deployment, possibly providing UE with multi-connectivity. Examples of anticipated co-existence scenarios are described below.

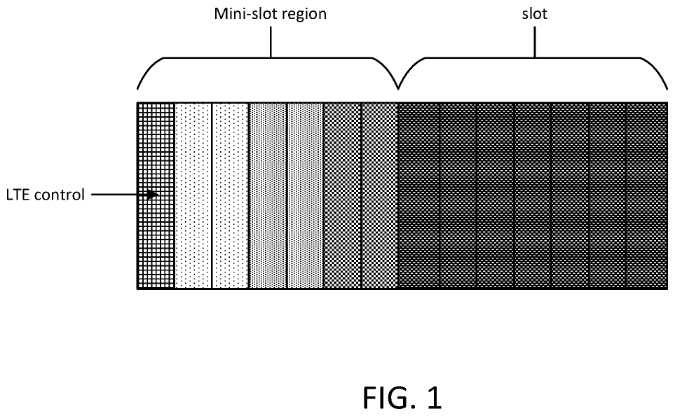

New Radio (NR) and LTE may coexist in Multicast-Broadcast Single Frequency Network (MBSFN) subframes. In LTE, up to 6 subframes may be configured as MBSFN subframes (1, 2, 3, 6, 7, 8). Furthermore, in LTE Rel-14, the number of allowable MBSFN subframes on a Secondary Cell (SCell) may be increased to 8 out of 10 subframes, and there may be no Physical Downlink Control Channel (PDCCH) region in these MBSFN subframes, e.g., by cross-carrier scheduling for LTE UEs. NR UEs may be scheduled in the LTE MBSFN subframe by avoiding the control region using mini-slot based scheduling. FIG. 1 illustrates an example of NR and LTE coexistence in MBSFN subframes in the same carrier, as described in R1-1704198, Coexistence of NR DL and LTE, RAN2#88bis, Huawei, which is hereby incorporated by reference in its entirety. As described herein, a subframe is an MBSFN subframe when the UE is configured with the said subframe as an MBSFN subframe.

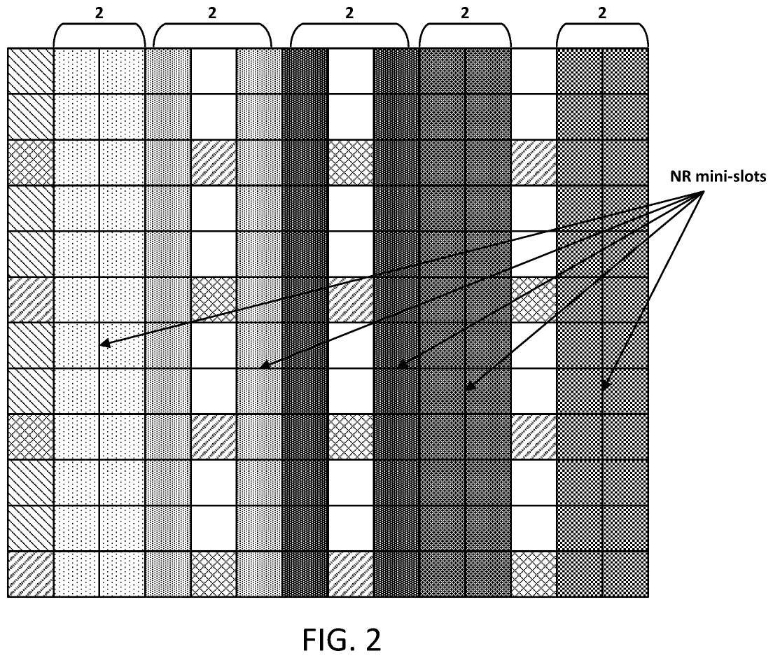

NR and LTE may coexist in non-MBSFN subframes. An example of NR and LTE co-existence in non-MBSFN subframes in the same carrier is illustrated in FIG. 2. While such an example is depicted in R1-1704198, Coexistence of NR DL and LTE, RAN2#88bis, under the context of NR DL co-existence, this co-existence use case may also apply to NR Uplink (UL) coexistence. As described herein, a subframe is a non-MBSFN subframe when the UE is not configured with the said subframe as an MBSFN subframe; from the UE perspective, the subframe is a regular subframe and not an MBSFN subframe. The time domain configuration methods and illustrative examples disclosed for non-MBSFN subframe may apply in downlink or uplink direction unless otherwise indicated.

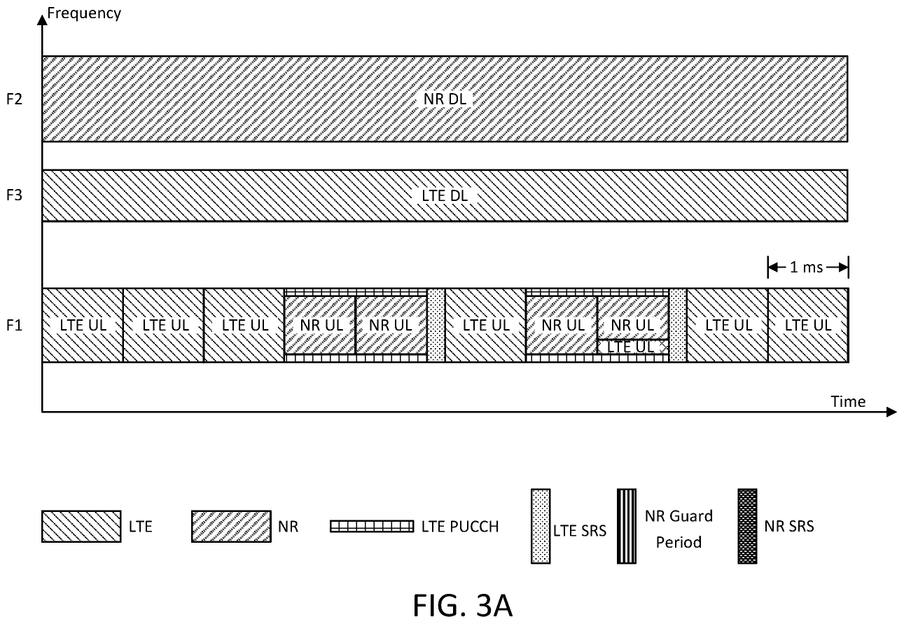

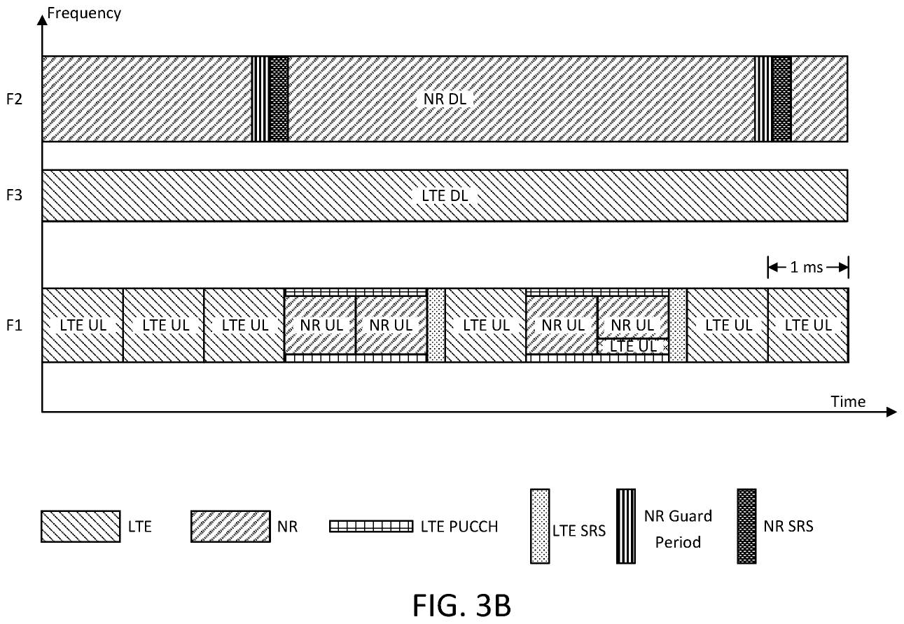

Another example deployment of NR and LTE is illustrated in FIGS. 3(a) and 3(b), as described in R1-1706905, Overview of NR UL for LTE-NR coexistence, RAN2#89, Huawei, which is hereby incorporated by reference in its entirety. LTE UL and NR UL may co-exist on the bandwidth of an LTE Frequency Division Duplex (FDD) component carrier F1. LTE Downlink (DL) may be on a paired frequency F2, and NR DL transmission may be on a frequency F2 different than the LTE DL frequency, as shown in FIG. 3(a). There may also be NR UL transmissions on frequency F2 if F2 is a Time Division Duplex (TDD) frequency, as shown in FIG. 3(b).

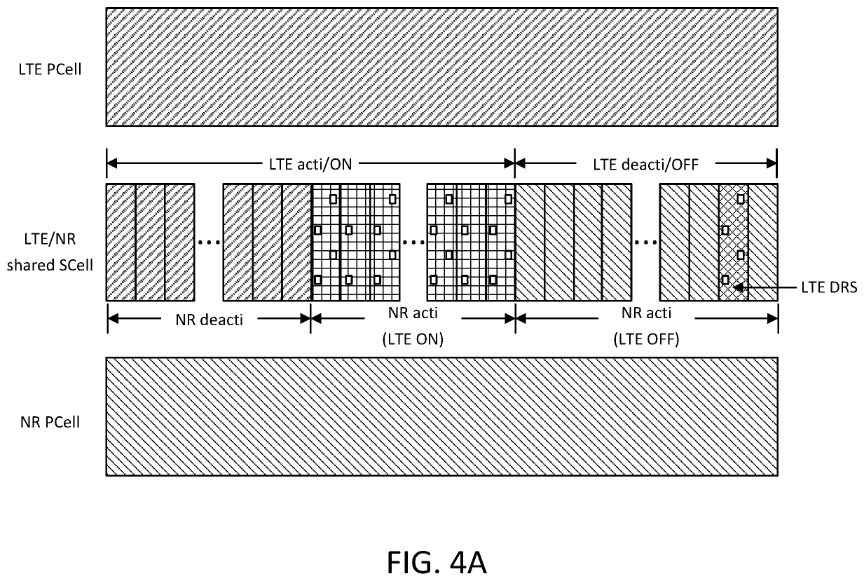

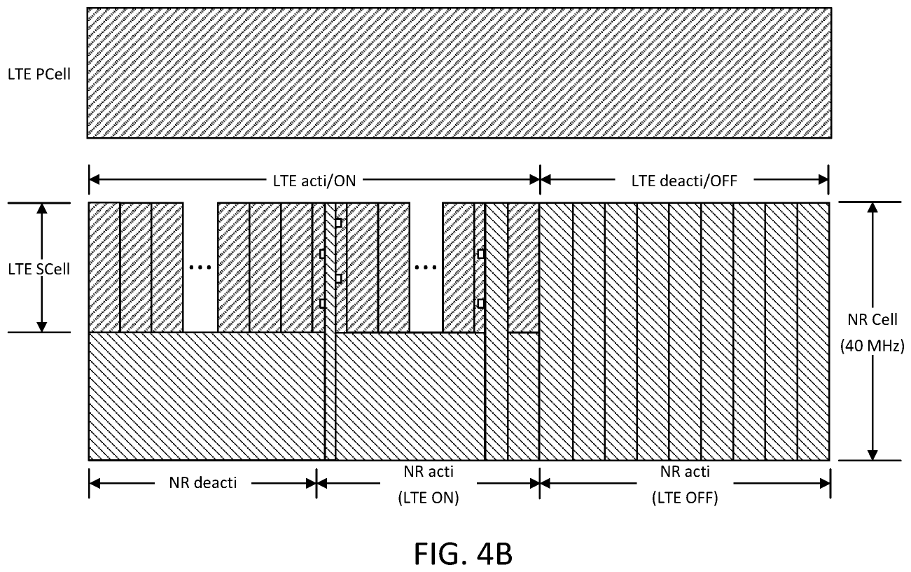

NR may coexist with LTE on an SCell. FIGS. 4(a) and 4(b) illustrate an example of NR coexistence with LTE on a cell where a Rel-12 LTE ON/OFF operation is supported based on an LTE SCell (de)activation mechanism. Such a coexistence may also be deployed with NR support for a cell/subband (de)activation mechanism or an NR bandwidth adaptation as shown in FIG. 4(b), the time scale of which should be at least in a Medium Access Control (MAC) Control Element (CE) level or a physical layer level (e.g., by group common NR PDCCH).

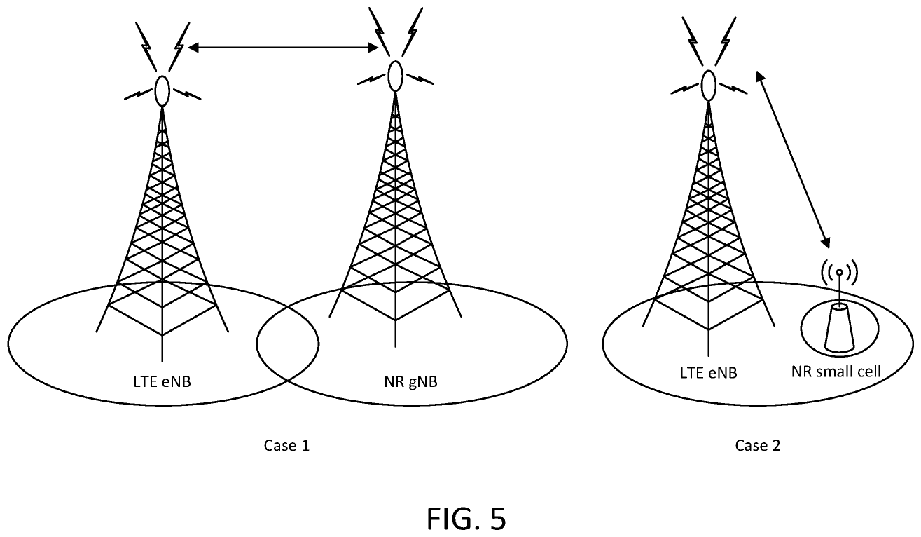

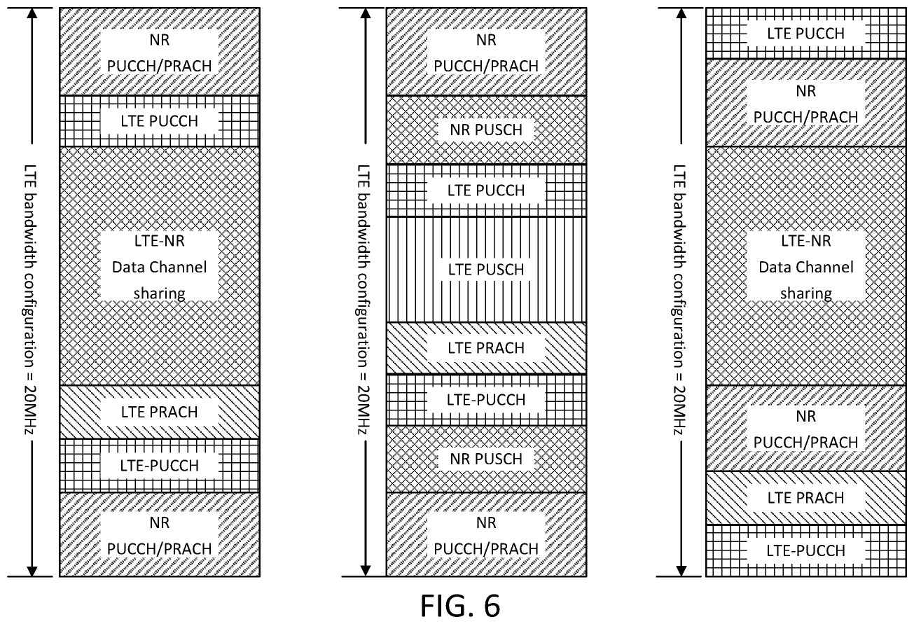

NR may coexist with LTE in cases where they are not collocated. FIG. 5 illustrates two example scenarios for LTE and NR coexistence. In case 1, NR and LTE coverage may overlap along a border between an NR deployment geographical area and an LTE deployment geographical area. Case 2 illustrates a hotspot NR deployment within an LTE coverage area. FIG. 6 illustrates three examples of UL resource sharing in a frequency domain between NR and LTE, as described in R1-1706905, Overview of NR UL for LTE-NR coexistence, RAN2#89.

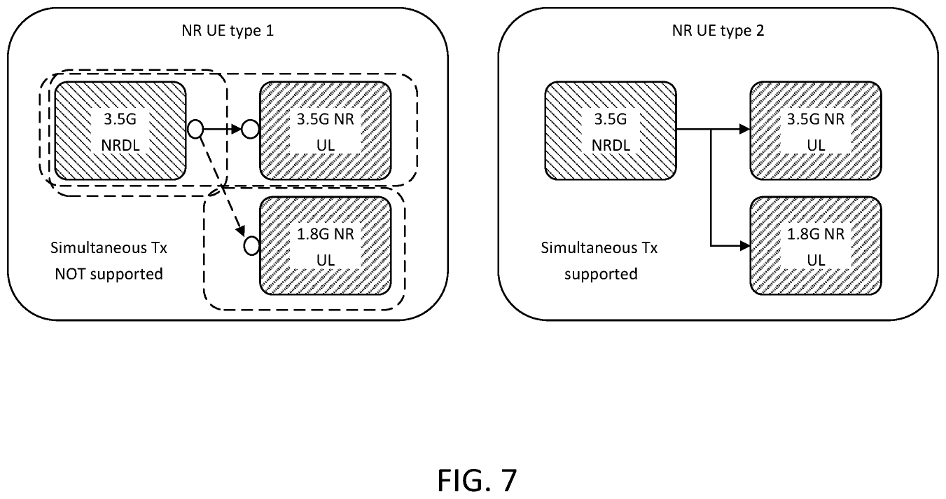

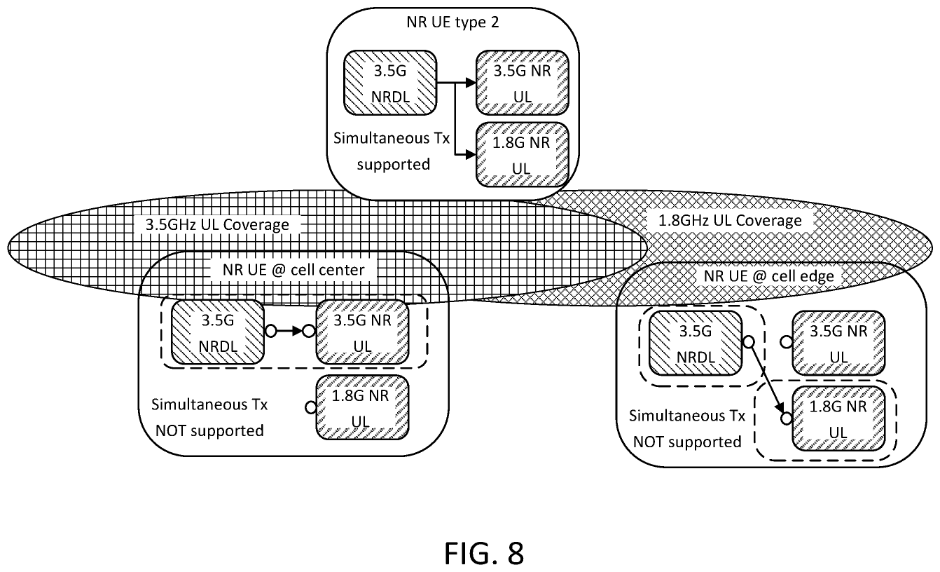

FIG. 7 illustrates two example types of UEs. In both types shown, the NR UE is configured with two UL carrier frequencies F1 (e.g., 1.8 GHz) that may be shared with LTE and frequency F2 (e.g., 3.5 Ghz). In type 1, the UE does not support simultaneous UL transmission. In type 2, the UE supports simultaneous UL transmission. As illustrated in FIG. 8, a UE such as the UEs of FIG. 7 may need to perform a UL carrier selection or carrier aggregation.

LTE and WLAN networks are widely deployed and are expected to co-exist with 5G networks for many years after 5G deployment, possibly providing UEs with multi-connectivity. Operators are likely to resort to LTE frequency spectrum refarming as a cost-effective way to redeploy existing spectrum for New Radio (NR) while providing service to legacy LTE UEs. As a result, portions of LTE time-frequency resources may need to be configured and signaled while NR resources may need to be addressed when LTE and NR share the same carrier on Uplink (UL), Downlink (DL), or both. Further, a UE may need to select a UL carrier frequency. When the NR UE is configured with more than one UL carrier frequency, for example frequency F1 and frequency F2, the two carriers may have different UL coverage. Additionally, a carrier frequency may be shared by another Radio Access Technology (RAT) (e.g., LTE or WLAN). As a result, a UL carrier may need to be selected in order to perform NR operation in idle mode, Radio Resource Control (RRC) Inactive mode, or RRC Connected mode. As described above, some NR UEs many not have the capability to operate simultaneously on more than one UL carrier frequency. Such UEs may need to determine which UL carrier to use. Furthermore, UEs capable of operating simultaneously on more than one UL carrier frequency may also need to select a UL carrier. For example, a UE may need to select a UL carrier when the UE is in idle mode and wishes to perform certain procedures, such as an initial access procedure. Another problem described herein is the problem of multi-connectivity across multiple RATs when a UE is capable of operating simultaneously on more than one RAT, e.g., NR and LTE, NR and WLAN, and/or NR, LTE and WLAN. As used herein, the terms “carrier,” “carrier frequency,” and “frequency” may be used interchangeably.

Example embodiments described herein may provide solutions to the above-described problems, among others, and may comprise the use of NR Resource Configuration in support of carrier sharing between NR and LTE. Example embodiments may comprise configuration at a radio subframe level, for both Multicast-Broadcast Single Frequency Network (MBSFN) subframes and non-MBSFN subframes. Additional example embodiments may comprise configuration at a mini-slot level, for both mini-slot level only configuration and a combination of subframe and mini-slot level configuration. Further example embodiments may comprise signaling mechanisms for NR resource configuration. Other example embodiments may comprise UL Carrier Selection in Idle Mode and Inactive Mode. Such UL Carrier Selection may be UE controlled and may have equal priority for carriers or unequal priority for carriers, both of which may have UL Path loss, Physical Random Access Channel (PRACH) transmit power, UL Power headroom, and UL Rx power and Rx Quality components. UL Carrier Selection may also be performed in an RRC Connected Mode. Yet other example embodiments may utilize a Multi-RAT MAC level Carrier aggregation Model.

In some embodiments, NR resource configuration may be performed at a radio subframe granularity level. In some cases, configuration may be performed at an MBSFN subframe level. LTE and NR may share the same carrier frequency in DL in a time domain multiplexing manner, which may be transparent to legacy LTE UEs. LTE subframe that can be configured by the LTE specification as MBSFN subframes (e.g., SubFrame (SF) 1, 2, 3, 6, 7, 8) may be configured for NR RAT. Subframe allocation patterns by the network may vary throughout the network and over time to take into account the LTE versus NR traffic patterns and load distribution throughout the network and over time. An NR Subframe configuration may be static or relatively dynamic, i.e., semi-static, in order to accommodate changing traffic patterns and load distribution over geographical areas and over time. While the configuration should be designed to allow for flexible subframe configuration as much as possible, considerations to UE performance, such as power consumption, and therefore battery life, and system access latency should be taken into account. The number of combinations of Subframe patterns and allocation splits between LTE RAT and NR RAT may be exponential, but an efficient signaling scheme may be designed to allow flexibility to the network in configuring NR subframes if the designed signaling is focused around configuration signaling design aspects such as the following: Subframe allocation period; subframes detail, i.e., the actual subframes configured within a subframe allocation period; subframe allocation repetition period; and subframe allocation modification period. Together, these attributes may allow the network the flexibility to define how static or how dynamic the NR subframe configuration is while taking into account potential excessive signaling drawback such as UE battery life, system access latency, and excessive air interface resource usage for signaling.

The network may configure some subframes for NR use only and other subframes for sharing between LTE and NR. However, from a signaling perspective, in a preferred embodiment, an NR UE may only need to determine if the subframe is configured as an NR subframe, regardless of whether or not the subframe may also be used by LTE UEs.

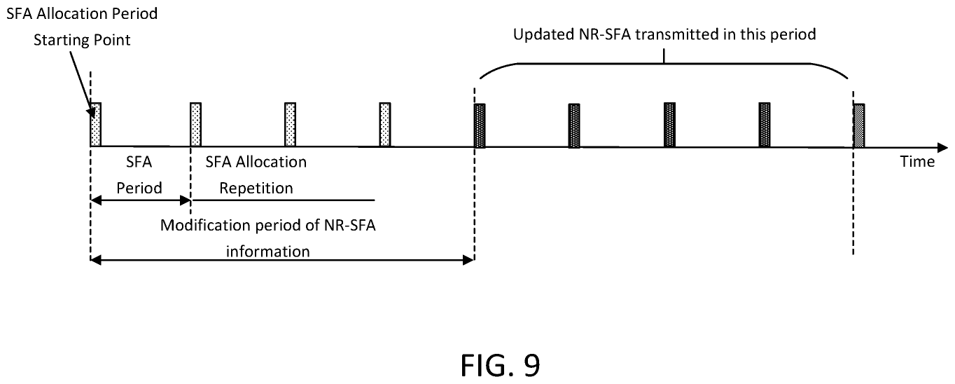

FIG. 9 illustrates the principles of subframe allocation period, subframe allocation period repetition, and subframe allocation modification period. A UE may assume a same subframe allocation in a follow-up modification period unless an update indication is received from the network.

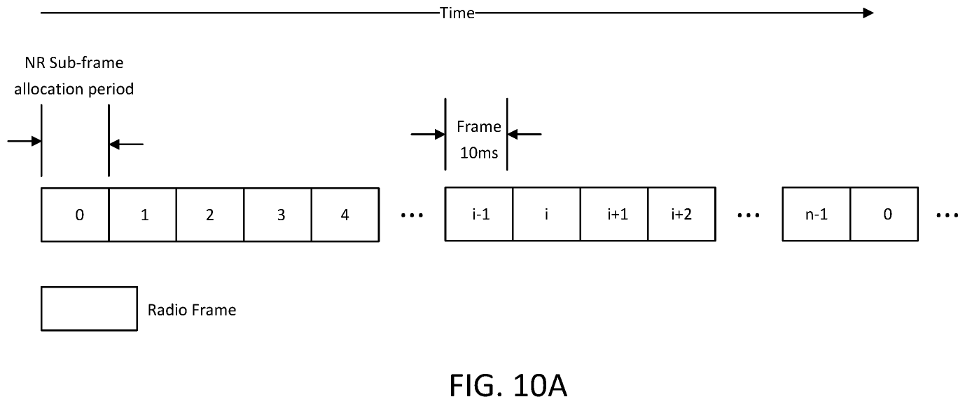

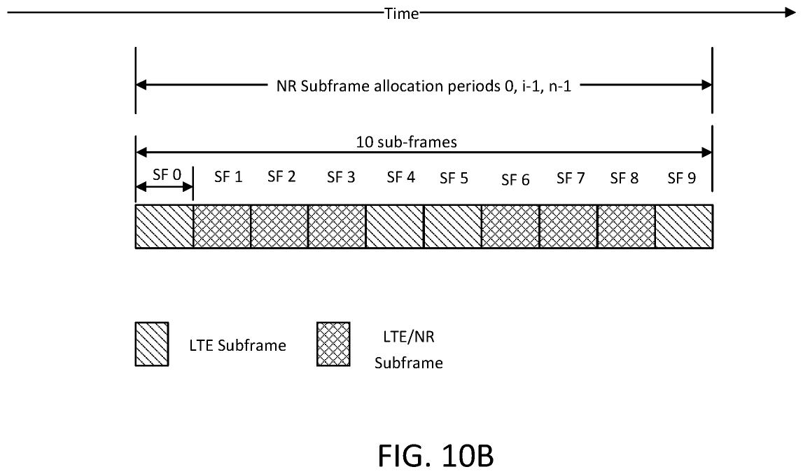

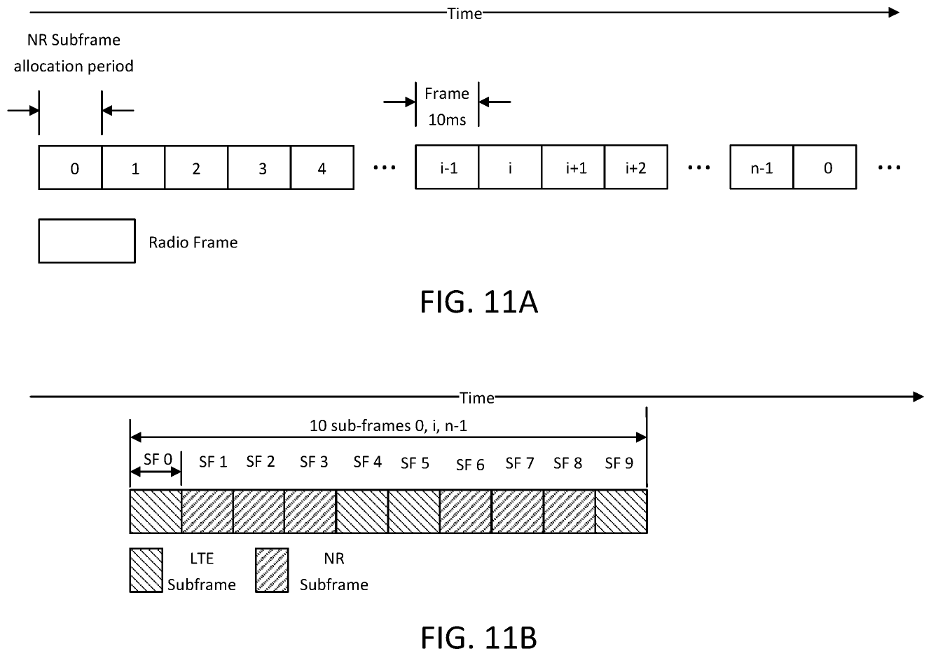

FIGS. 10 and 11 illustrate examples of NR subframe configuration using MBSFN subframes where an NR subframe allocation (SFA) period is one LTE radio frame (10 subframes) long and has a repetition period of one radio frame and a modification period of n radio frames long. In the example shown in FIGS. 10 and 11, six MBSFN subframes are configured as an NR subframe in each radio frame. FIG. 10 illustrates a configuration scenario where the network may also assign resource grants to legacy UEs within the configured NR subframes. FIG. 11 illustrates an example configuration scenario where only NR UEs are assigned resource grants in the MBSFN subframe configured for NR.

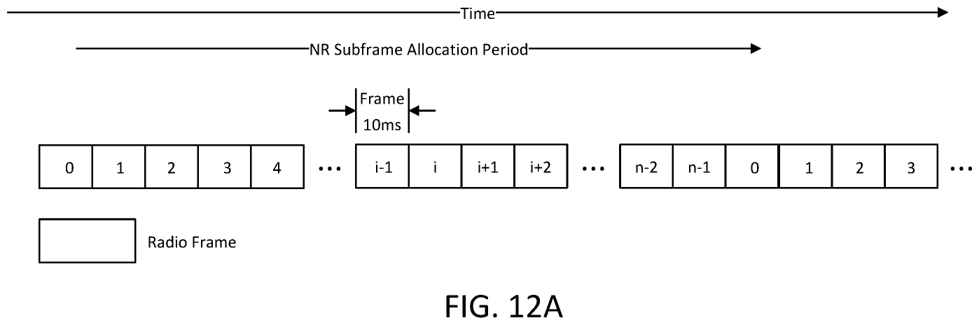

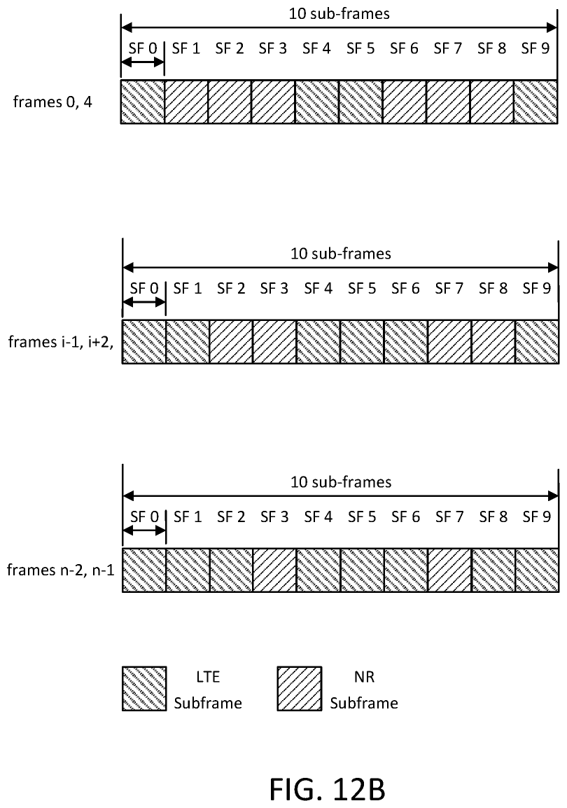

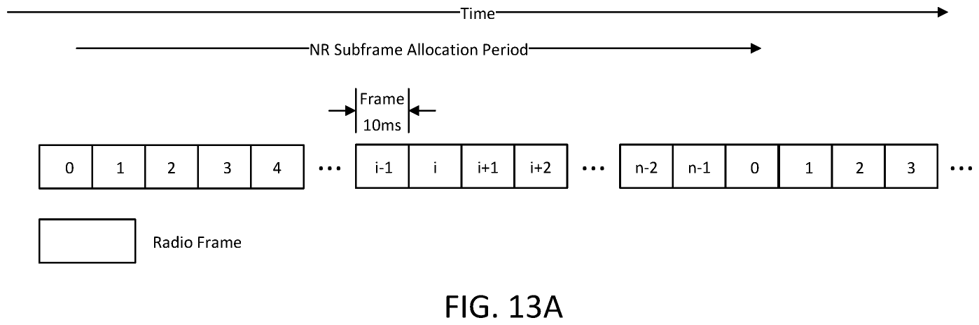

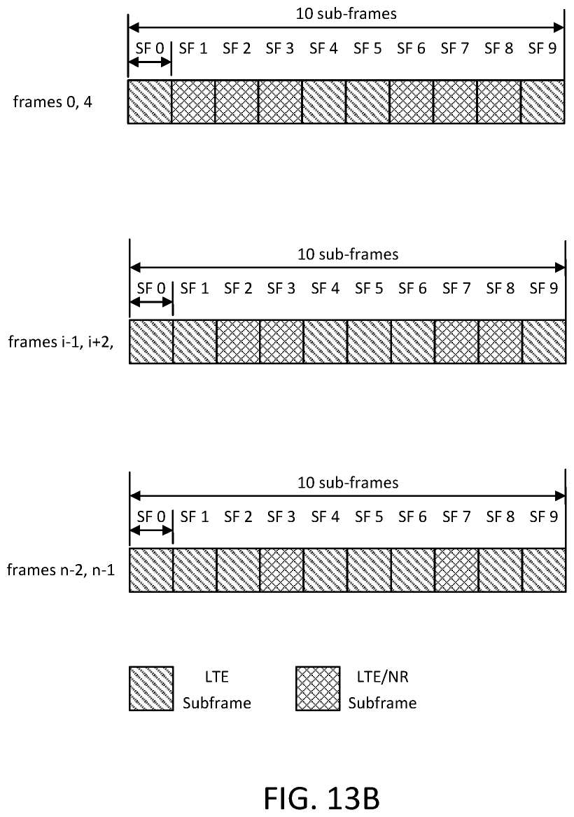

FIGS. 12 and 13 illustrate examples of MBSFN subframe configurations as NR subframes where the SFA period is multiple LTE radio frames long. Within such an SFA period, a different number of MBSFN subframes are configured for NR RAT within a radio frame within a radio frame. A longer SFA period may support a more flexible NR subframe configuration with the ability to change NR frame configuration on a radio-frame basis.

An SFA configuration may be a downlink-only configuration, an uplink-only configuration, or may be both a downlink and an uplink configuration, i.e., NR resource allocation in those subframes maybe for UL operation only, DL operation only, or both downlink operation and uplink operation. For example, in an example embodiment where a carrier associated with an SFA is configured for NR UEs as a DL-only carrier, the SFA may relate to downlink. In an example embodiment where the carrier associated with the SFA is configured for NR UEs as UL-only carrier, the SFA may relate to uplink. In an example embodiment where the carrier is being shared with LTE and is configured for NR UEs as both a UL and a DL carrier, the SFA may indicate the direction of the frame allocation: UL, DL, or both. Alternatively, the subframe allocation may not indicate the direction of the frame allocation. Direction information may be subsequently communicated to the UE through resource grant allocation signaling separately from subframe configuration signaling.

In addition to the parameters defined above, the concept of SFA frame offset may also be defined. For example, an SFA frame offset may be defined such that an SFA modification period fulfills the following relation with respect to the System Frame Number (SFN): SFN Mod (Modification Period)=frameOffset, where the parameter frameOffset may also be signaled to the UE as part of the NR resource configuration information. The Mod( ) operator may refer to the modulo function. The parameter frameOffset may be an integer and may take the value zero (0). Different values of frame offset may also be defined and may be referenced by a frame offset index. The network (e.g., gNB) may then signal the frame offset index to the UE as part of the NR resource configuration information.

Predefined MBSFN subframe patterns for NR subframe configurations may also be specified and may defined such that each pattern may be referenced by a specified index. Similarly, predefined NR time-frequency resource patterns may be defined such that each pattern may be referenced by a specified index. A UE may be configured with one or more resource configuration pattern indices.

In an alternative example embodiment, an NR resource configuration may be a combination of predefined resources patterns or an NR resource location in time-frequency domain, and the NR resource configuration may be provided to the UE through a resource configuration scheme such as the resource configuration scheme illustrated in FIG. 9.

In some embodiments, NR resource configuration may be performed at a radio subframe granularity level using non-MBSFN subframes. LTE and NR may share the same carrier frequency in DL or in UL in a time domain multiplexing manner, which may be transparent to legacy LTE UEs. Any of the ten LTE subframes within a radio frame, i.e., SF 0,1,2, 3 . . . , 9, may be configured for NR RAT. A subframe configuration for NR may be based on configuration principles similar to those depicted in FIG. 9, with the use of an SFA period, an SFA allocation repetition period, and an SFA modification period. The network may configure some subframes for NR use only and other subframes for sharing between LTE and NR. However, from a signaling perspective, in a preferred embodiment, the NR UE may only need to know if the subframe is configured as an NR subframe, regardless of whether or not the subframe may also be used by LTE UEs. Further details about signaling design are described later in this specification.

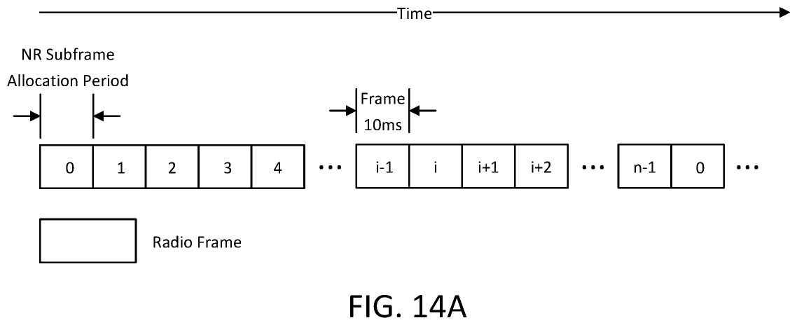

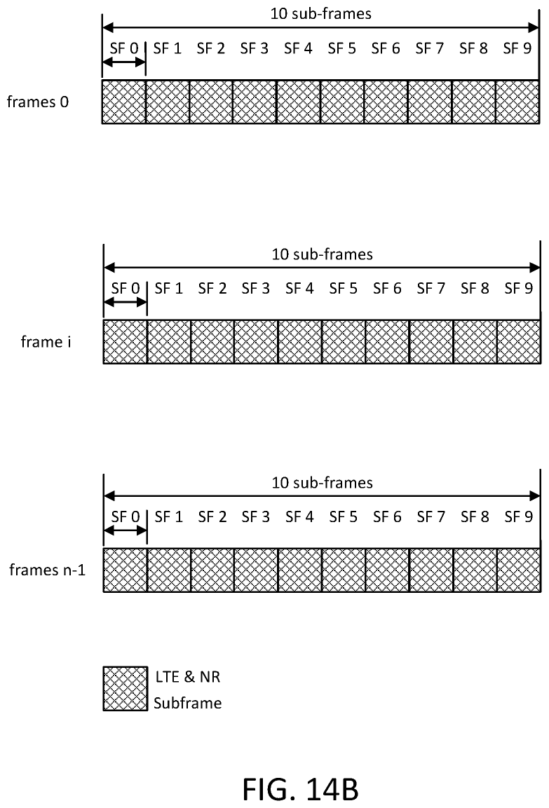

FIG. 14 illustrates an example of an NR subframe configuration using non-MBSFN subframes where the NR subframe allocation (SFA) period is one LTE radio frame (10 subframes) long with a repetition period of one radio frame and a modification period of n radio frames long. While the NR subframes configuration in this example are also depicted as potentially being shared by LTE, the network may decide to assign resource grant (at the time of resource grant allocation by the scheduler) in some of the subframes exclusively to NR UEs, while in some other subframes the network may decide to assign resource grant (at the time of resource grant allocation by the scheduler) in some of the subframes exclusively to LTE UEs. From the NR UE perspective, the NR UEs may only need to determine via static or semi-static configuration whether or not the UE may be assigned NR resource grants within a subframe. Alternatively, the network may also determine via static or semi-static configuration, to exclude some subframes from use by NR UEs, i.e., there may not be resource grants assigned by the scheduler to NR UEs within those subframes. NR UEs may sleep and save power during such subframes and therefore extend battery life.

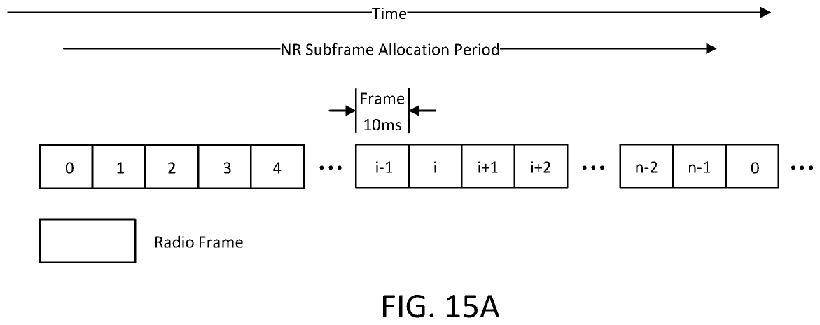

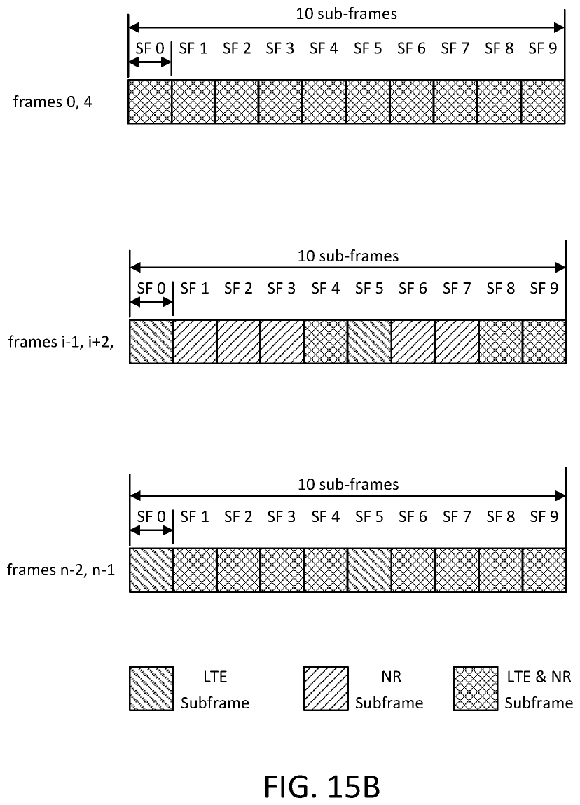

FIG. 15 illustrates an example of non-MBSFN subframe configurations as NR subframes where the SFA period is multiple LTE radio frames long. In the example of FIG. 15, some subframe are configured as NR subframes (potentially shared by LTE) while some subframes are shown as LTE-only subframes, i.e., these frames as not configured as NR subframes, and the NR UE may not expect NR resource grant assignment in such subframes.

As with configuration of MBSFN subframes as NR subframes, the SFA configuration may be a downlink-only configuration, an uplink-only configuration, or may be both a downlink and an uplink configuration, i.e., NR resource allocation in those subframes may be for UL operation only, DL operation only, or both downlink and uplink operation. For example, in an example embodiment where a carrier associated with an SFA is configured for NR UEs as a DL-only carrier, the SFA may relate to downlink. In an example embodiment where the carrier associated with the SFA is configured for NR UEs as UL-only carrier, the SFA may relate to uplink. In an example embodiment where the carrier is being shared with LTE and is configured for NR UEs as both a UL and a DL carrier, the SFA may indicate the direction of the frame allocation: UL, DL, or both. Alternatively, the subframe allocation may not indicate the direction of the frame allocation. Direction information may be subsequently communicated to the UE through resource grant allocation signaling separately from subframe configuration signaling.

Predefined non-MBSFN subframe patterns for NR subframe configurations may also be specified and may defined such that each pattern may be referenced by a specified index. Similarly, predefined NR time-frequency resource patterns may be defined such that each pattern may be referenced by a specified index. A UE may be configured with one or more resource configuration pattern indices.

In an alternative example embodiment, an NR resource configuration may be a combination of predefined resources patterns or an NR resource location in time-frequency domain, and the NR resource configuration may be provided to the UE through a resource configuration scheme such as the resource configuration scheme illustrated in FIG. 9.

In example embodiments, the configuration of NR resources, i.e., the resources of the shared carrier in support of an NR operation, may be configured at a mini-slot granularity level. NR resource configuration may be based on one or a combination of the following example methods regarding mini-slot level only configuration and a combination of subframe and mini-slot level configuration.

Example embodiments may use a combination of subframe and mini-slot level configurations to configure NR resources. In such embodiments, the NR resource configuration in time domain may comprise subframe level configuration and mini-slot configuration within an allocated subframe. Subframe configuration may be performed via one of the methods described above. For example, using the configuration scheme illustrated in FIG. 9, subframe allocation may be characterized by an SFA period, an SFA repetition period, and an SFA modification period. Within the SFA allocation period, the UE should be configured with the mini-slot configuration for each subframe within the SFA period. Several approaches may be considered.

In a first example approach, each subframe within an SFA allocation period may have the same mini-slot configuration. Potential NR mini-slot patterns within a subframe may be pre-defined in the standard where each pattern is referenced by standardized index. NR Mini-slot within a subframe in a SFA may be signaled to the UE.

In a second example approach, the subframes within a SFA period may have different mini-slot configurations. Potential NR mini-slot patterns within a subframe may be pre-defined in the standard where each pattern is referenced by a standardized index. The signaling may also indicate a non-predefined mini-slot pattern to the UE, e.g., based on mini-slot allocation period, allocation repetition period, and modification period within the confinement of a subframe, following a scheme similar to the one described in FIG. 9 for subframe configuration.

In another example embodiment using a combination of subframe and mini-slot level configurations, the subframe configuration pattern may be predefined and standardized with each subframe configuration pattern referenced by a standardized index. The mini-slot configuration within the subframe configuration pattern may be based on an approach such as those described above.

Example embodiments may use only mini-slot level configurations to configure NR resources. The NR resource configuration in time domain may be done directly at mini-slot level. In such embodiments, mini-slot configuration pattern may not be confined to the boundary of a subframe. Mini-slot configuration may be defined following one of the following example approaches.

In a first example approach, the mini-slot configuration may use the principle of mini-slot allocation period, mini-slot allocation repetition period, and mini-slot allocation repetition period similar to the scheme described in FIG. 9 for subframe configuration.

In a second example approach, predefined mini-slot patterns over Mini-Slot Allocation (MSA) period may also be specified, i.e., defined such that each pattern may be referenced by a specified index. Similarly, predefined NR time-frequency resources patterns may be defined such that each pattern may be referenced by a specified index. The UE may be configured with one or more resource configuration pattern index.

In an alternative embodiment, the NR resource configuration at mini-slot level may be a combination of predefined resources patterns of NR resource location in time-frequency domain complemented with NR resource configuration provided to the UE through NR mini-slot level resource configuration as described in the first example approach described above.

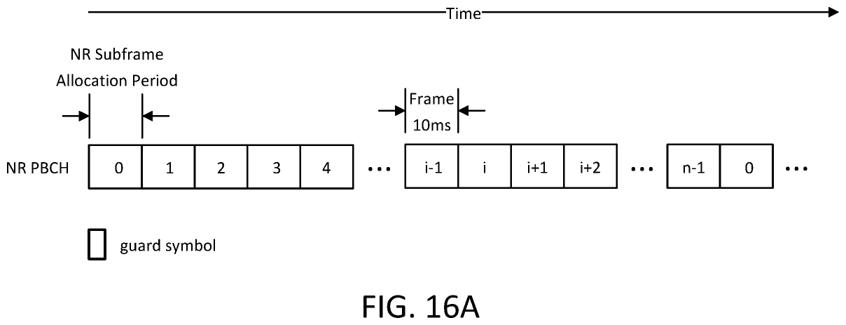

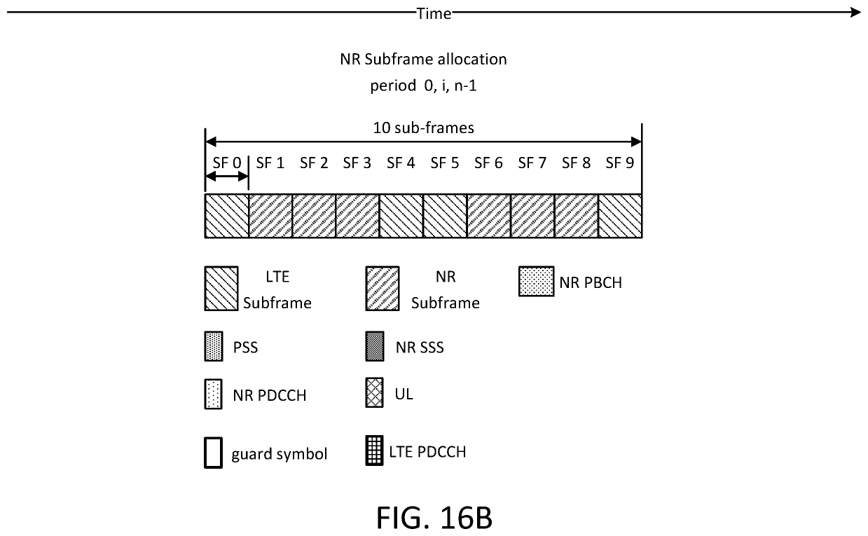

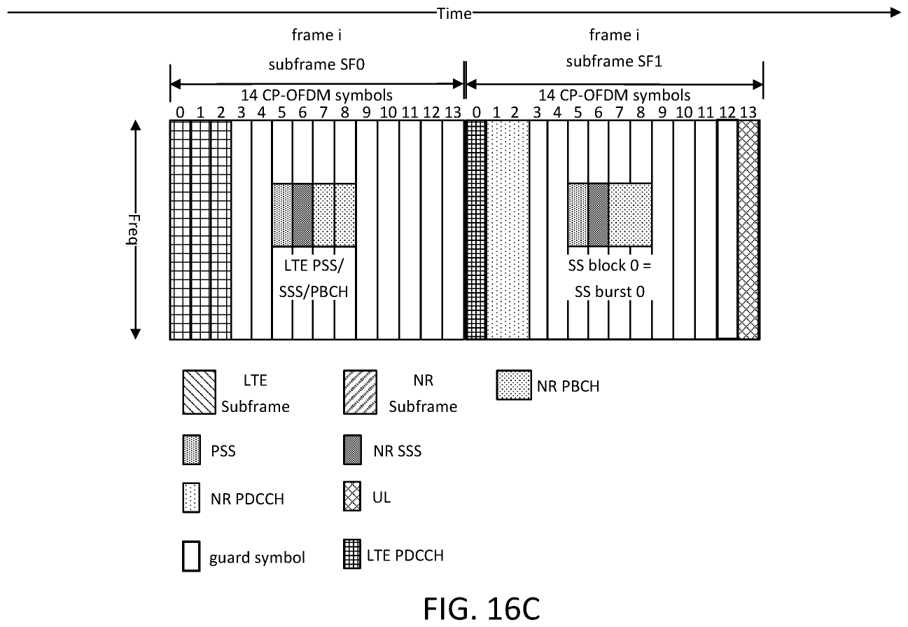

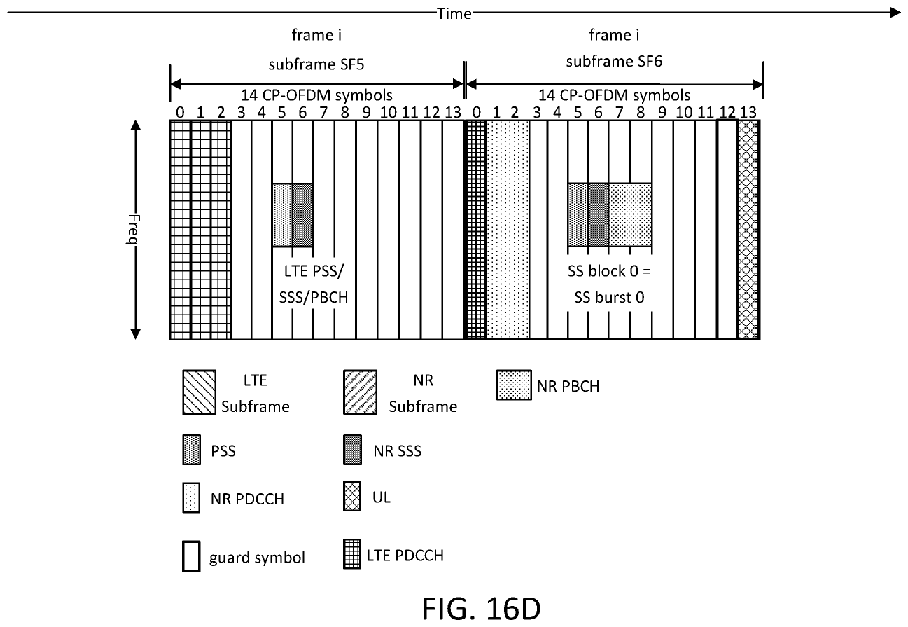

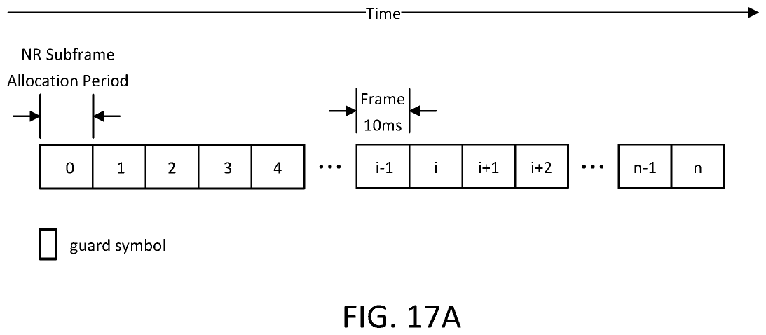

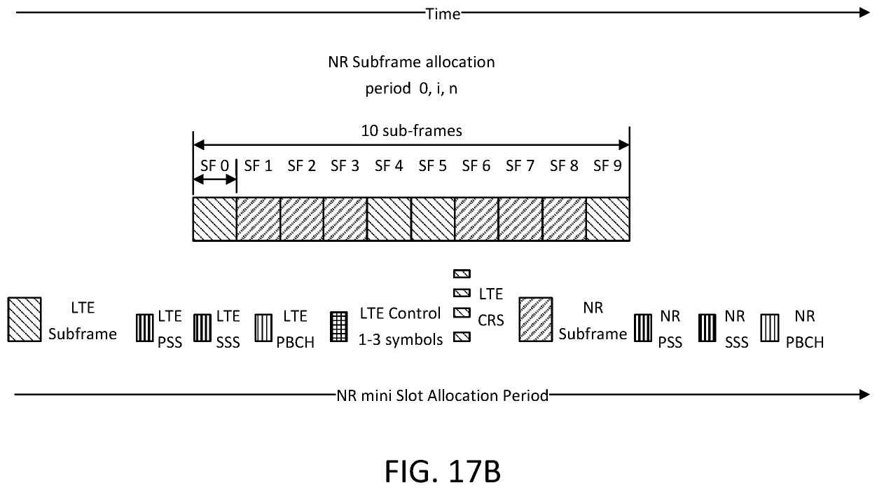

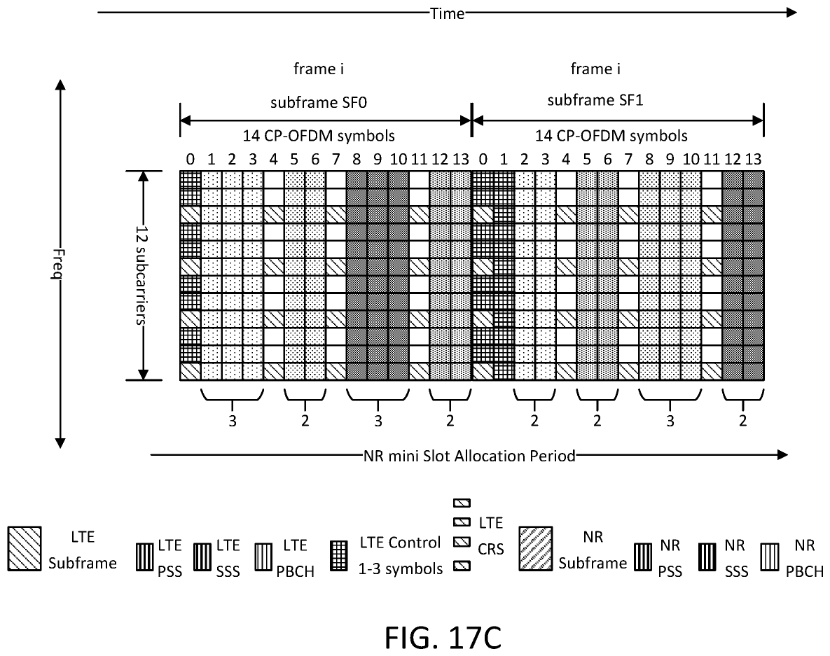

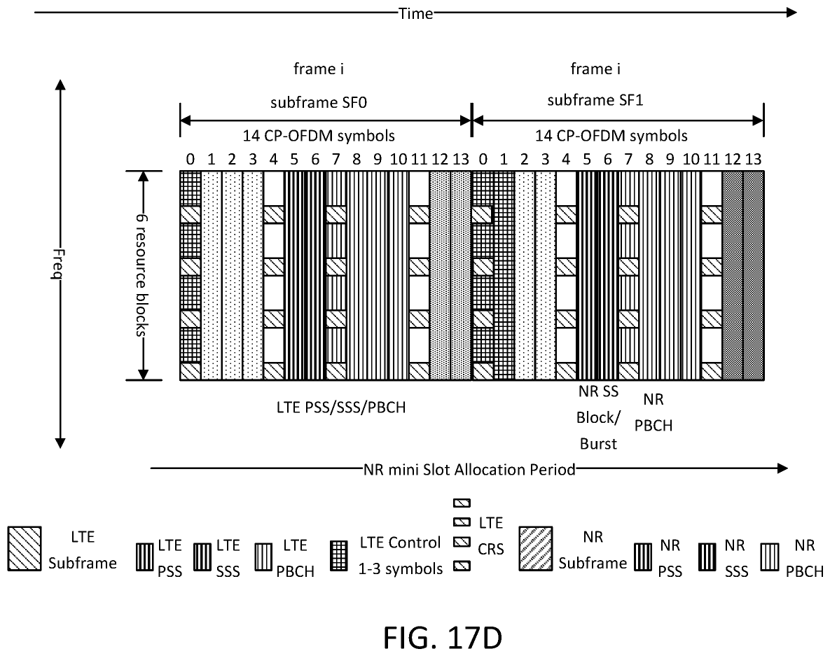

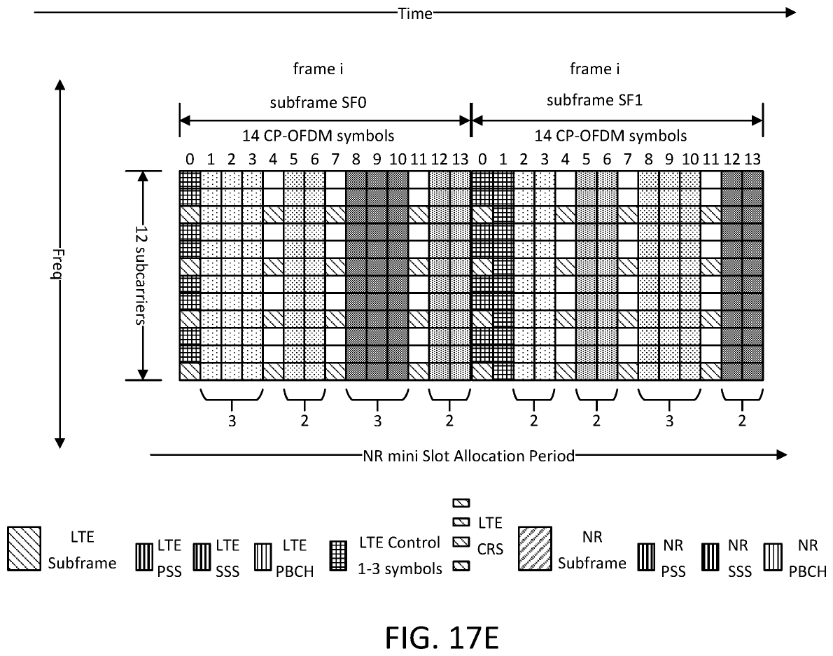

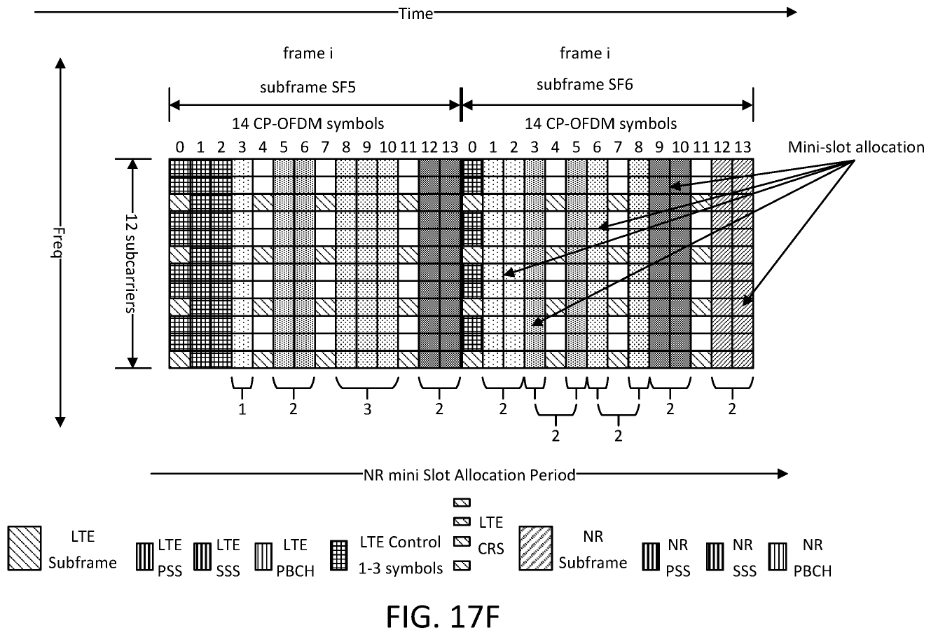

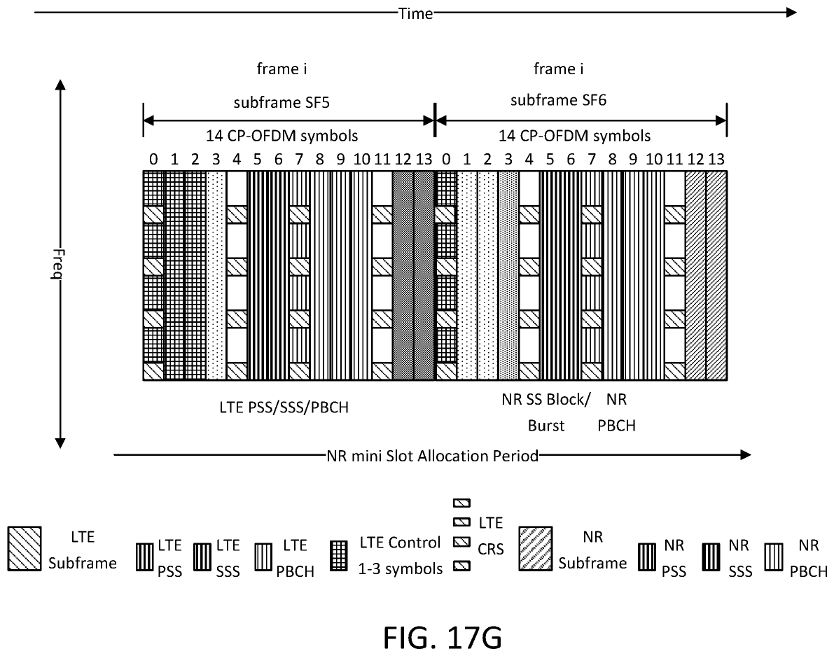

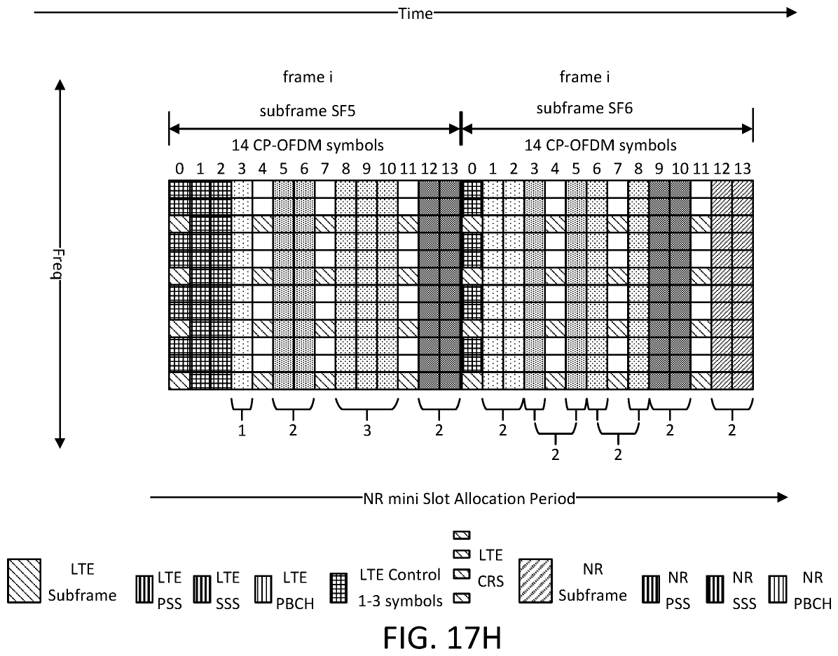

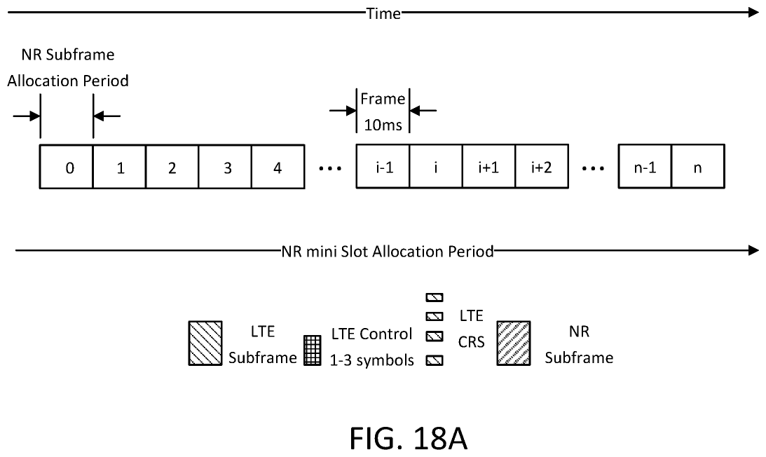

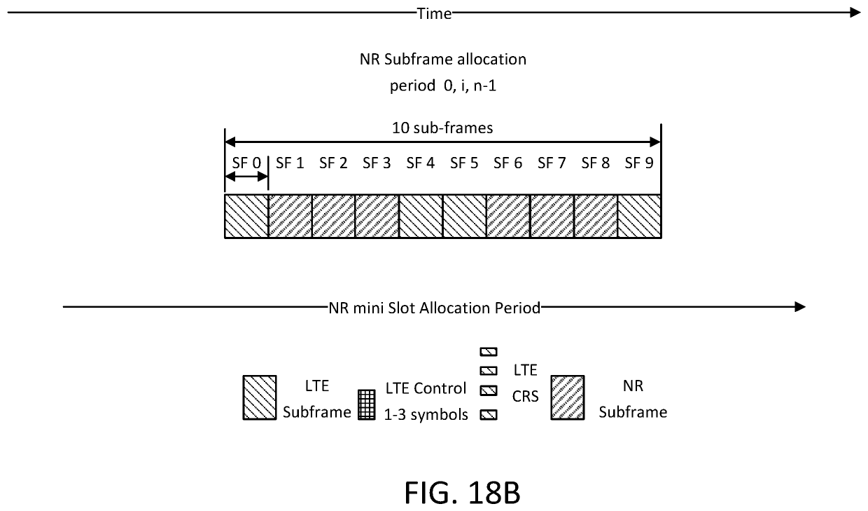

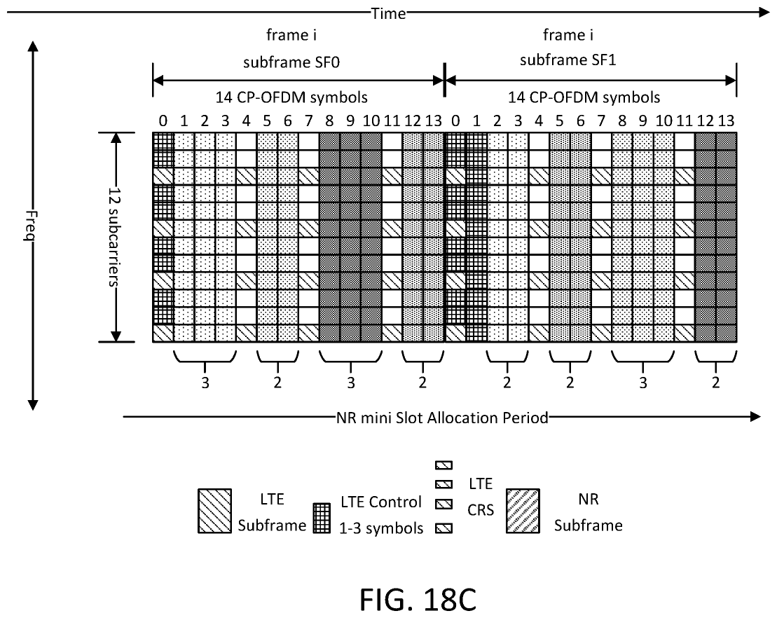

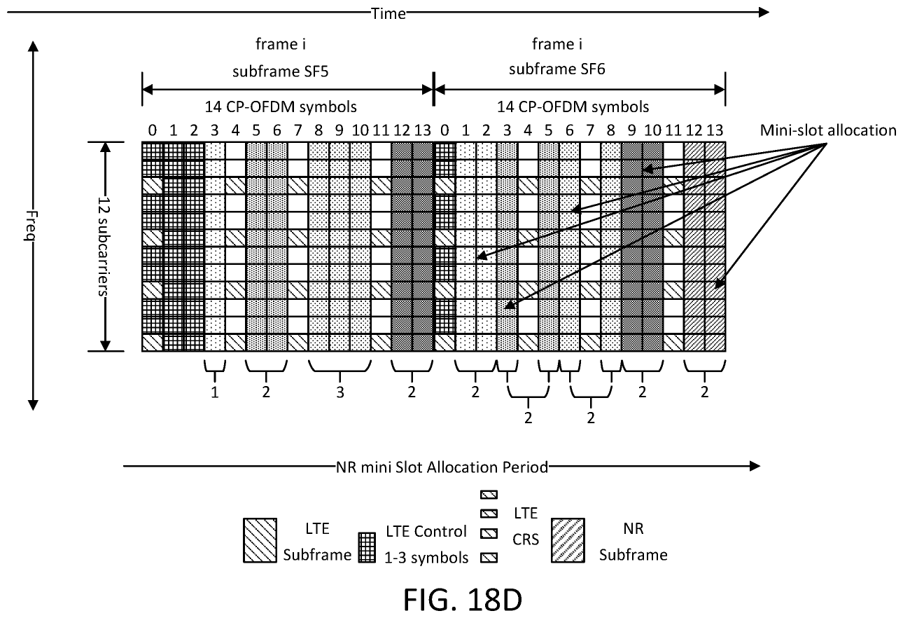

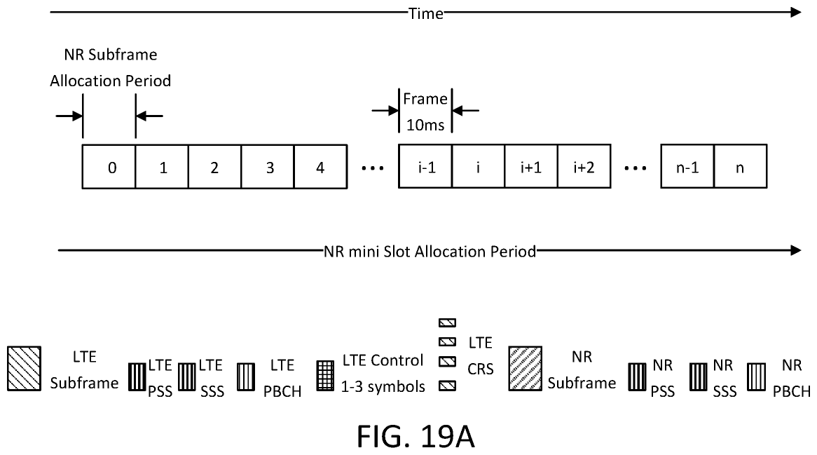

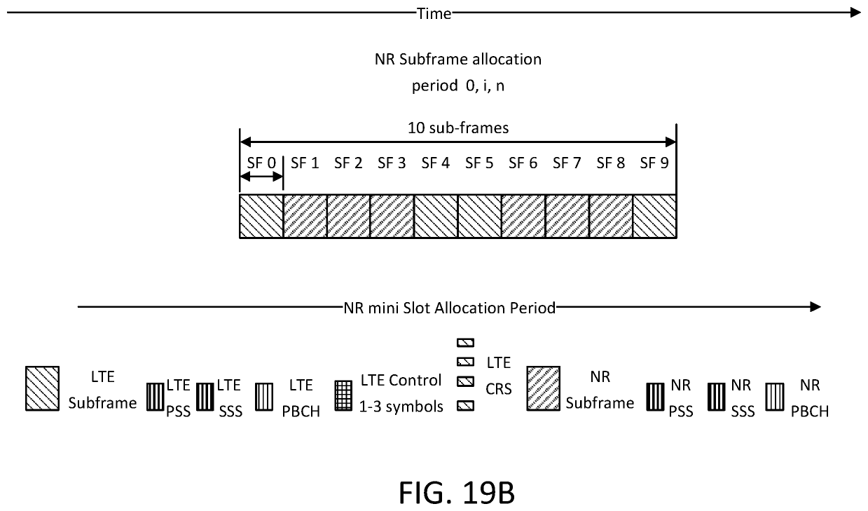

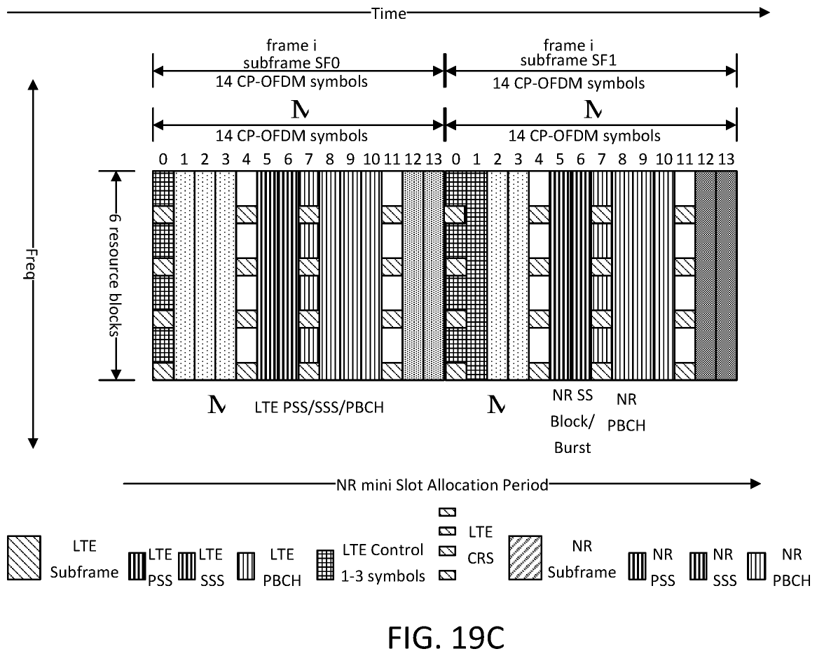

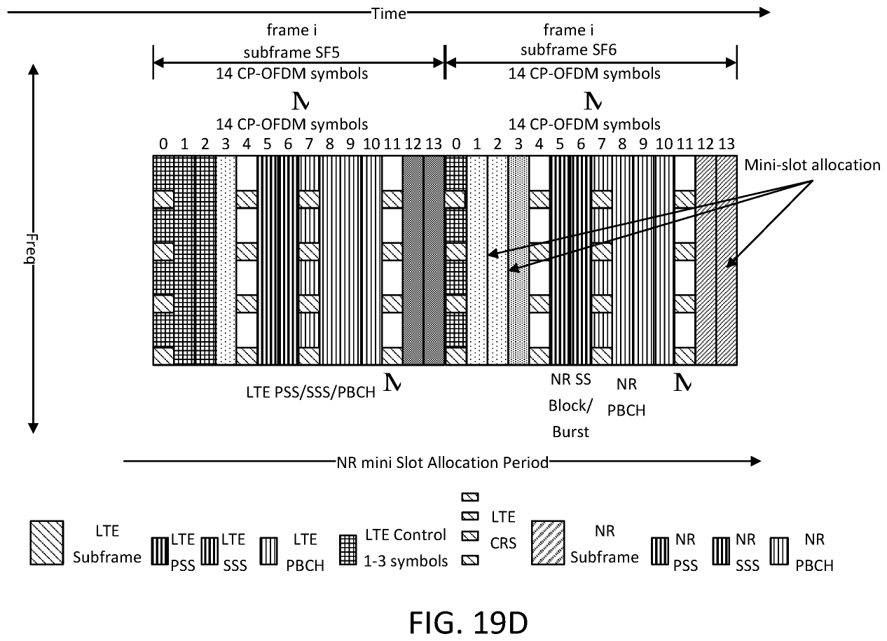

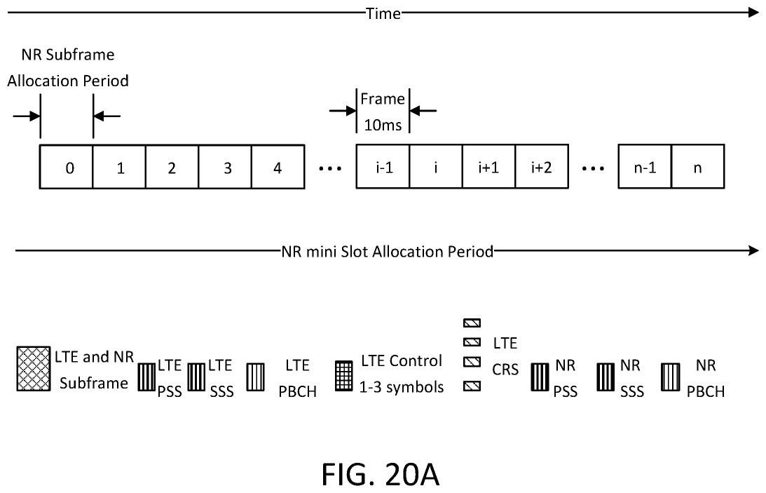

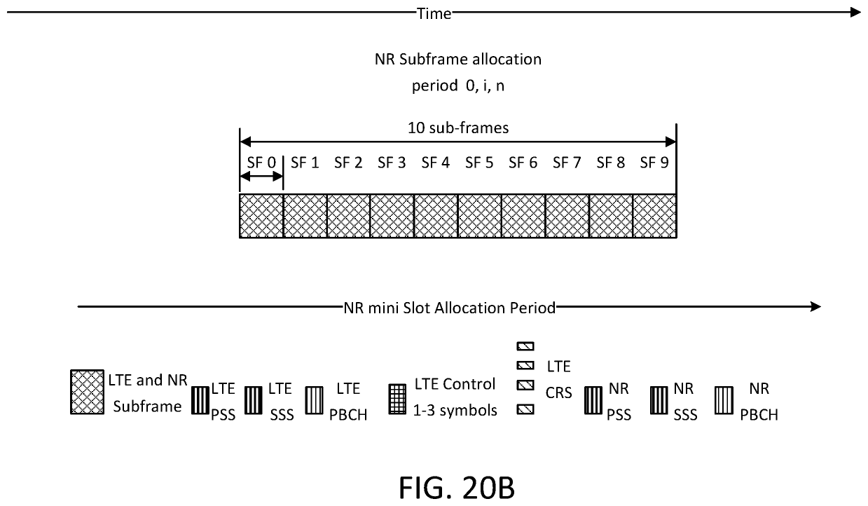

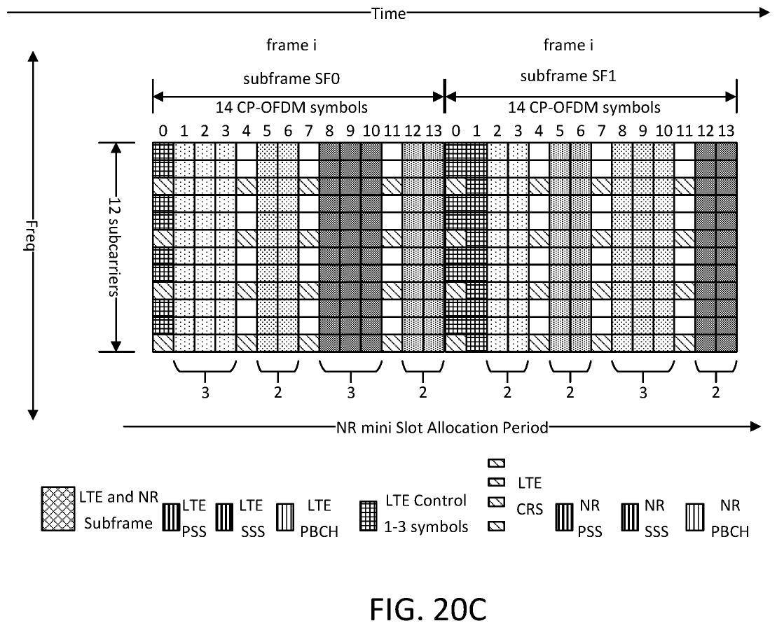

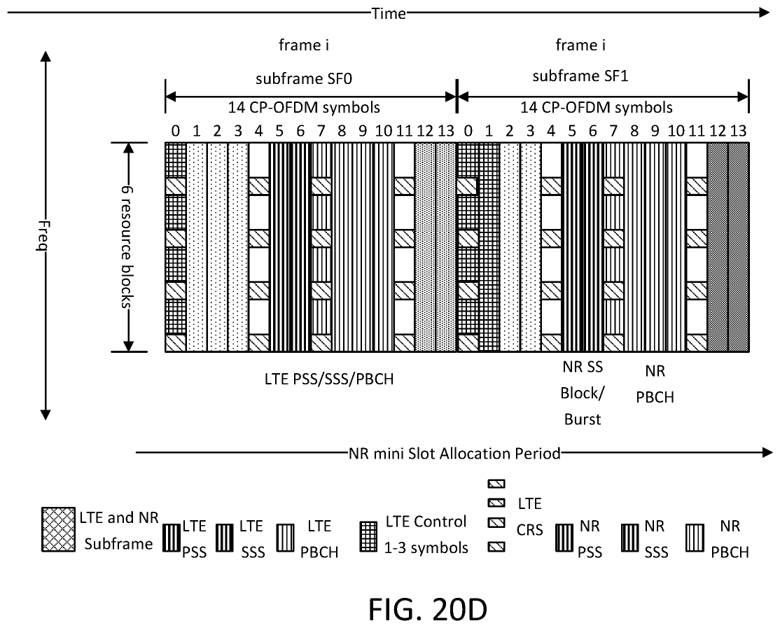

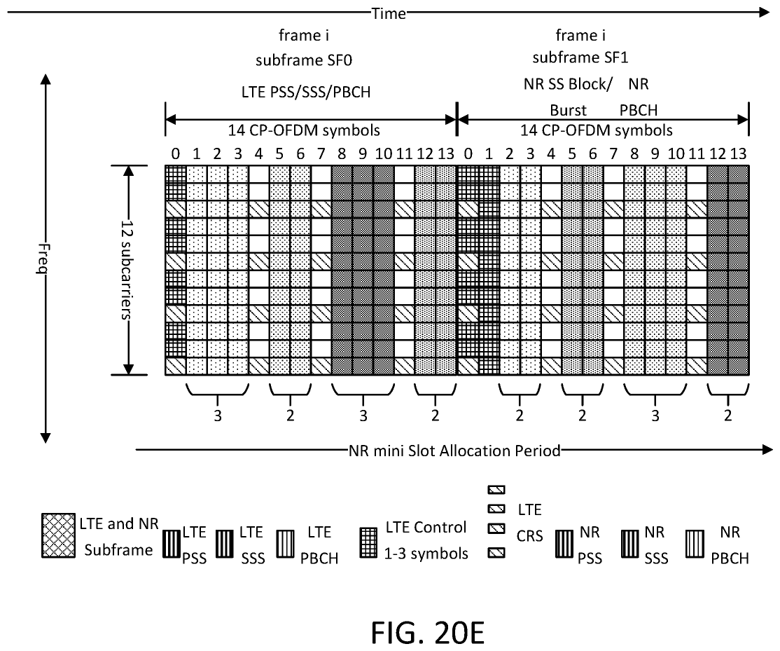

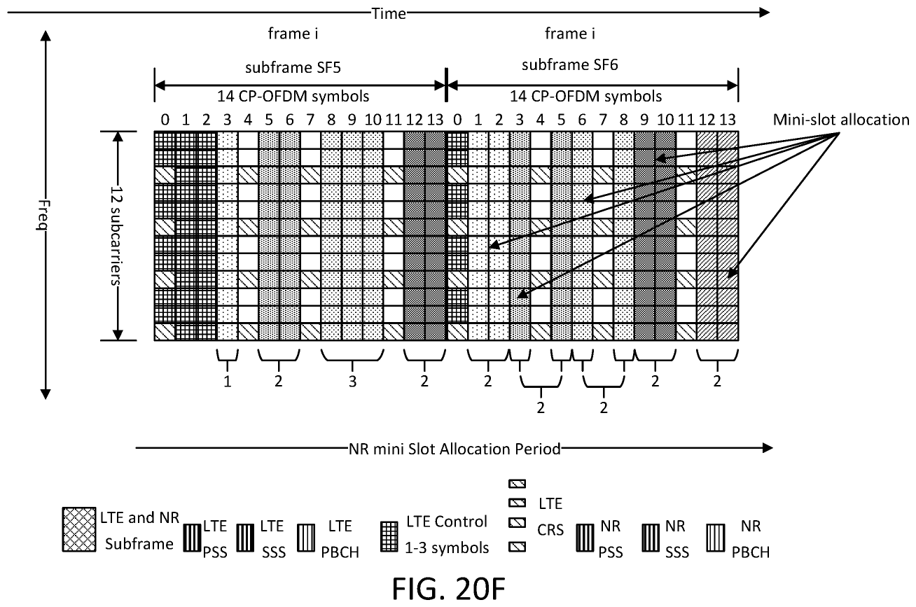

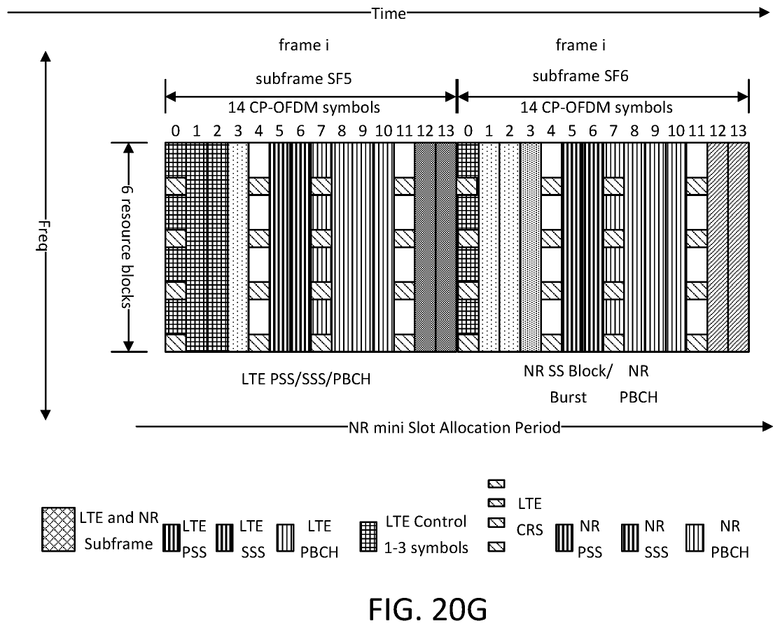

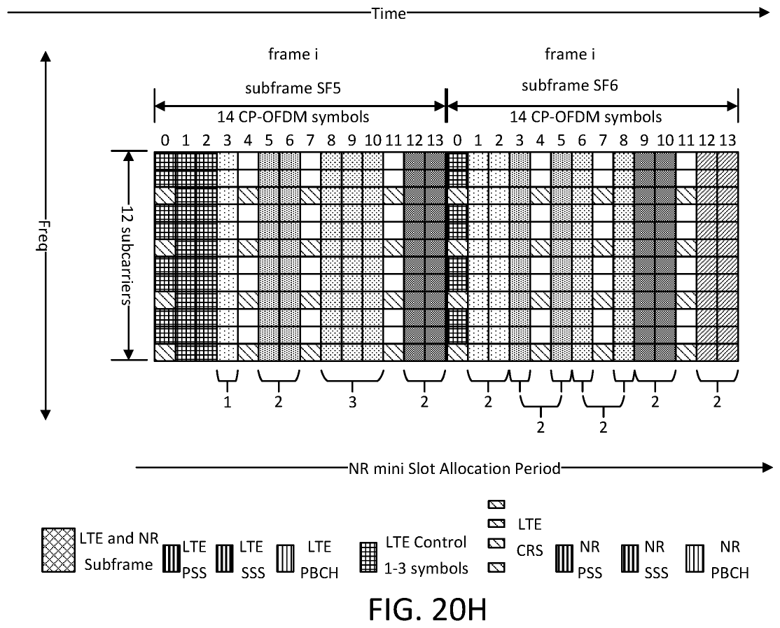

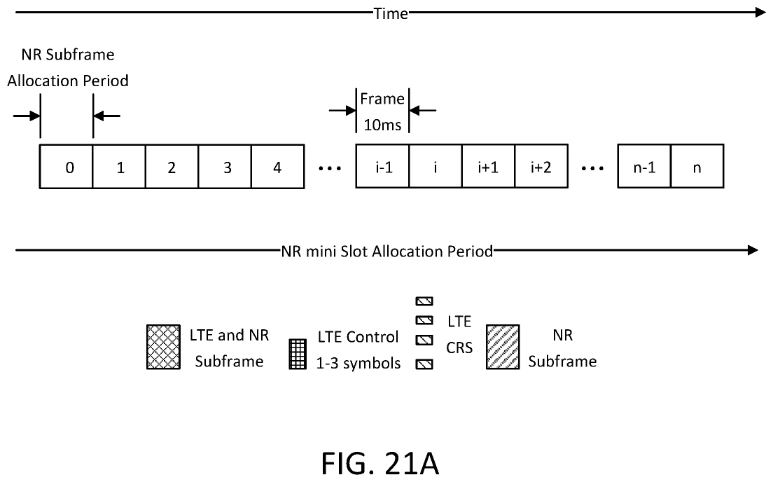

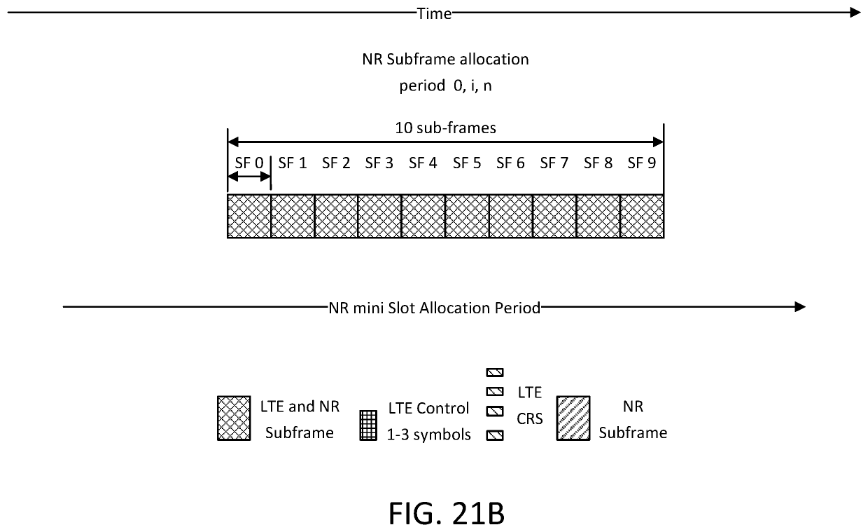

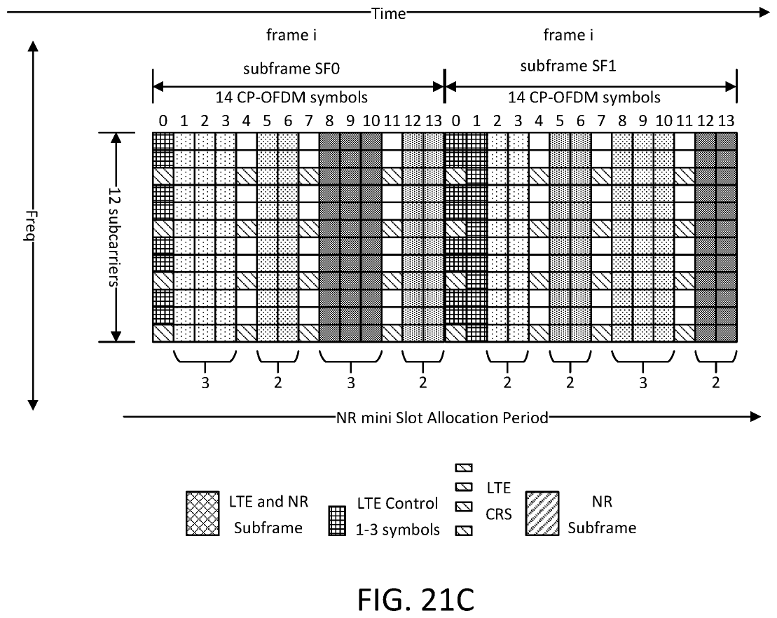

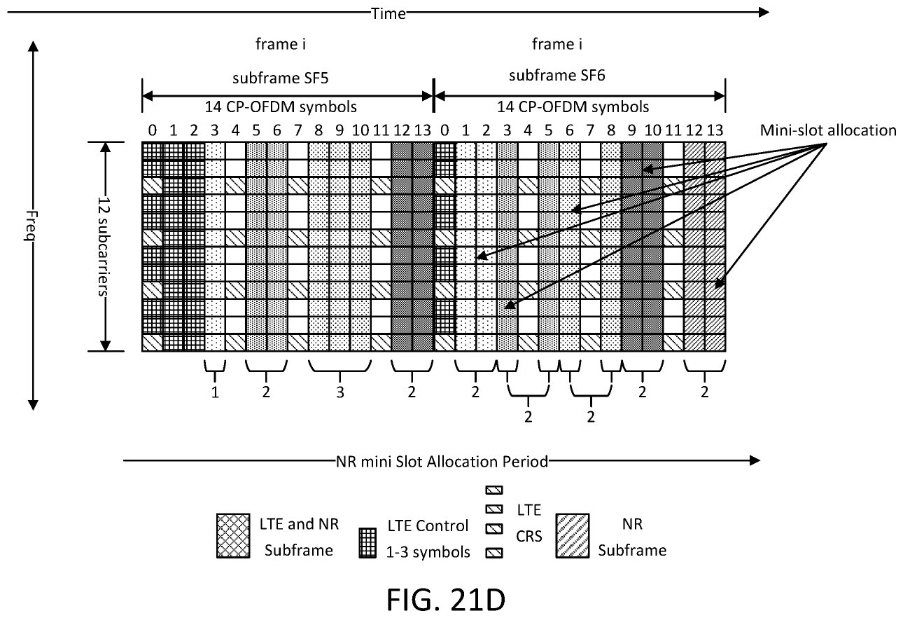

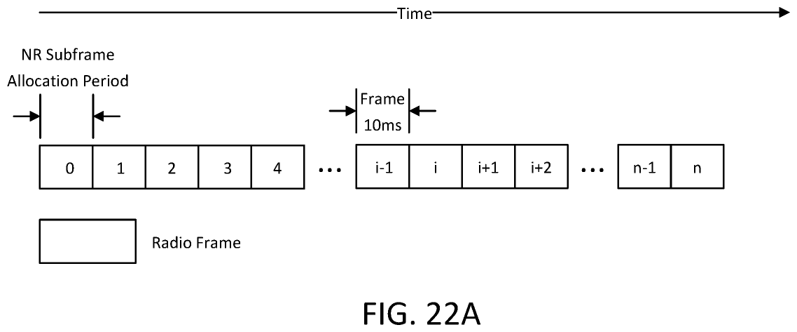

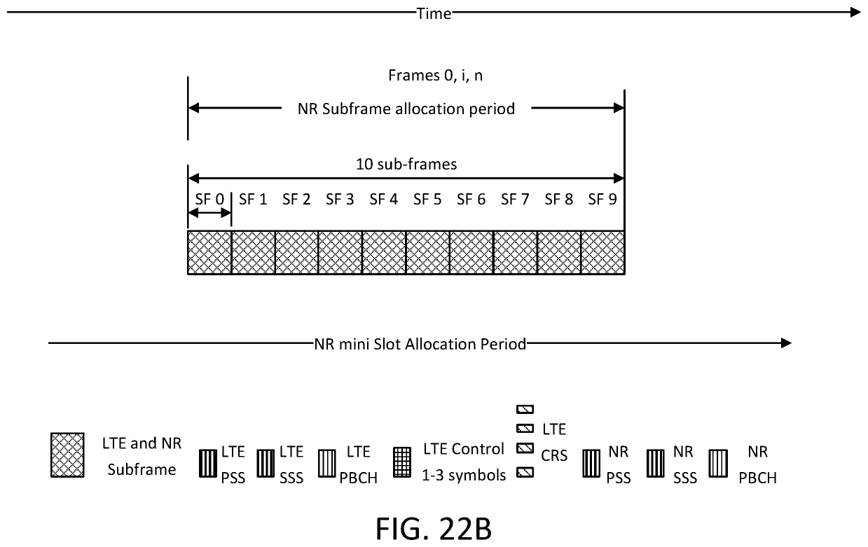

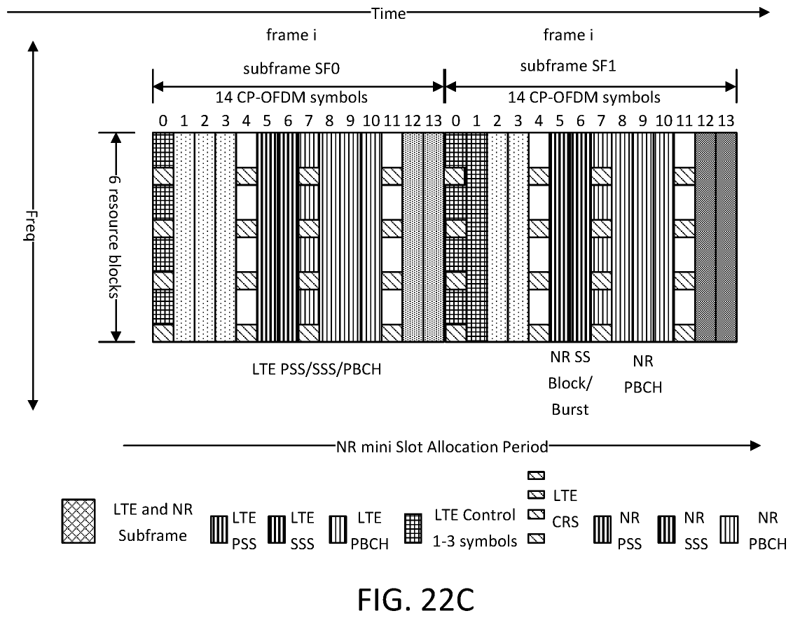

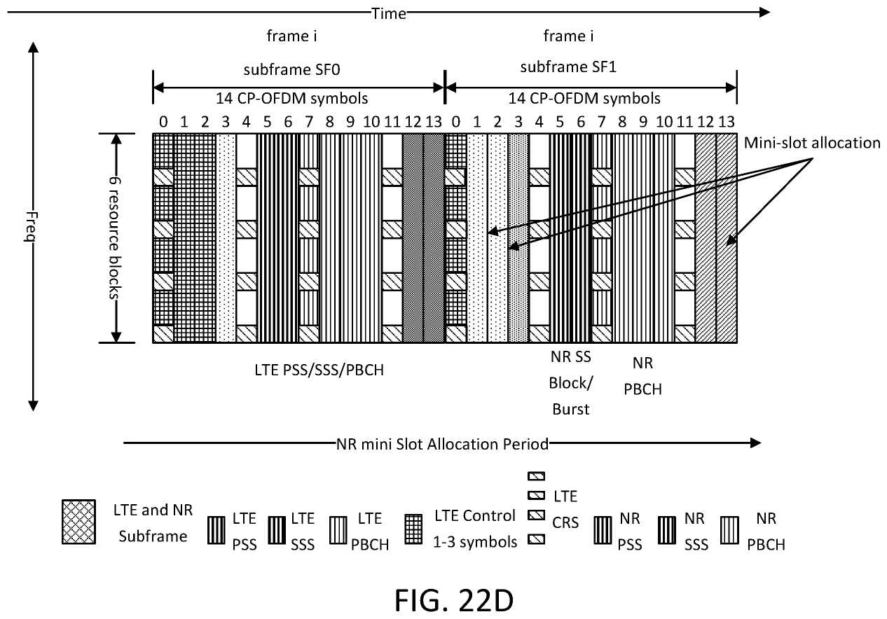

Various examples of mini-slot level configuration of NR resources (in downlink) in case of co-existence with LTE are illustrated in FIGS. 16-22. While frequency domain resource allocation for NR SSs and NR PBCH are shown to be twice that of LTE PSS/SS and LTE BCH, respectively, in the subframes where they are present, the frequency domain resource allocation for NR SSs and NR PBCH may be different. For example, NR SSs and NR PBCH may occupy in a frequency domain twice the frequency domain resources occupied by LTE PSS/SSS and LTE PBCH, respectively. The configuration of symbols as NR mini-slots may vary in frequency domain from one frequency region to another within the same LTE subframe or LTE time slot. For example, in the six center resource blocks, i.e., the center six resource blocks as illustrated in FIGS. 17A-B, FIG. 19, FIGS. 20A-B, FIG. 22, symbol 5, and symbol 6 of subframe 0 and subframe 5 may not be allocated as NR mini-slots as these slots may be used for LTE PSS and LTE SSS. However, outside of this frequency region, these symbols may be used for NR mini-slot allocation. Similarly, Symbol 7, 8, 9, and 10 of subframe 0 may not be used for NR mini-slots allocations as these symbols may be used for LTE PBCH transmission. However, outside of the six center resource blocks frequency region, these slots may be used for NR mini-slot allocation. The use of six center resource blocks in this example as resources allocated to NR SSs and NR PBCH is for illustrative purposes and should not be construed as limiting. The specified frequency domain resources that may be used for NR SSs and NR PBCHs may be different from six resource blocks. For example, NR SSs and NR PBCH may occupy more than six resource blocks. A resource block in LTE may comprise 12 subcarriers in frequency domain and one symbol in time domain.

Example embodiments may perform NR Resource Configuration in a frequency domain. LTE Resource sharing with NR in frequency domain, i.e., a frequency domain multiplexing (FDM) scheme of LTE and NR resource sharing, is another important consideration. FIG. 6, described above, illustrates three different examples of configuration for LTE and NR resource allocation in frequency domain. FIGS. 16-22 also provide examples for frequency domain resource sharing between LTE and NR, more particularly the allocation of frequency domain resources in support of NR signals and channels such as NR synchronization signals and an NR Physical broadcast channel (NR PBCH).

In addition to configuration parameters described above, such as SFA period, SFA allocation repetition, SFA modification period, and SFA frame offset (e.g., as described with regard to radio subframe granularity level configuration), the NR resource configuration may include frequency domain configuration parameters. Examples of such parameters may be one or more of the following:
NR PUCCH lower-end frequency offset: indicates the first resource block allocated to NR PUCCH starting from the lower end of the frequency range of the shared carrier.
NR PUCCH lower-end bandwidth: Number of resource block allocated to NR PUCCH in the lower-end of the frequency range of the shared carrier.
NR PUCCH upper end frequency upset: indicates the first resource block allocated to NR PUCCH starting from the upper end of the frequency range of the shared carrier.
NR PUCCH lower-end bandwidth: Number of resource block allocated to NR PUCCH in the upper-end of the frequency range of the shared carrier.
NR PUSCH lower-end frequency offset: indicates the first resource block allocated to NR PUSCH starting from the lower end of the frequency range of the shared carrier.
NR PUSCH lower-end bandwidth: Number of resource block allocated to NR PUSCH in the lower-end of the frequency range of the shared carrier.
NR PUSCH upper-end frequency offset: indicates the first resource block allocated to NR PUSCH starting from the upper-end of the frequency range of the shared carrier.
NR PUSCH upper-end bandwidth: Number of resource block allocated to NR PUSCH in the upper-end of the frequency range of the shared carrier.
NR PRACH lower-end frequency offset: indicates the first resource block allocated to NR PRACH starting from the lower end of the frequency range of the shared carrier.
NR PRACH lower-end bandwidth: Number of resource block allocated to NR PRACH in the lower-end of the frequency range of the shared carrier.
NR PRACH upper-end frequency offset: indicates the first resource block allocated to NR PRACH starting from the upper-end of the frequency range of the shared carrier.
NR PRACH upper-end bandwidth: Number of resource block allocated to NR PRACH in the upper-end of the frequency range of the shared carrier.
NR PBCH lower-end frequency offset: indicates the first resource block allocated to NR PBCH starting from the lower end of the frequency range of the shared carrier.
NR PBCH lower-end bandwidth: Number of resource block allocated to NR PBCH in the lower-end of the frequency range of the shared carrier.
NR PBCH upper-end frequency offset: indicates the first resource block allocated to NR PBCH starting from the upper-end of the frequency range of the shared carrier.
NR PBCH upper-end bandwidth: Number of resource block allocated to NR PBCH in the upper-end of the frequency range of the shared carrier.
NR SS lower-end frequency offset: indicates the first resource block allocated to NR SS starting from the lower end of the frequency range of the shared carrier.
NR SS lower-end bandwidth: Number of resource block allocated to NR SS in the lower-end of the frequency range of the shared carrier.
NR SS upper-end frequency offset: indicates the first resource block allocated to NR SS starting from the upper-end of the frequency range of the shared carrier.
NR SS upper-end bandwidth: Number of resource block allocated to NR SS in the upper-end of the frequency range of the shared carrier.

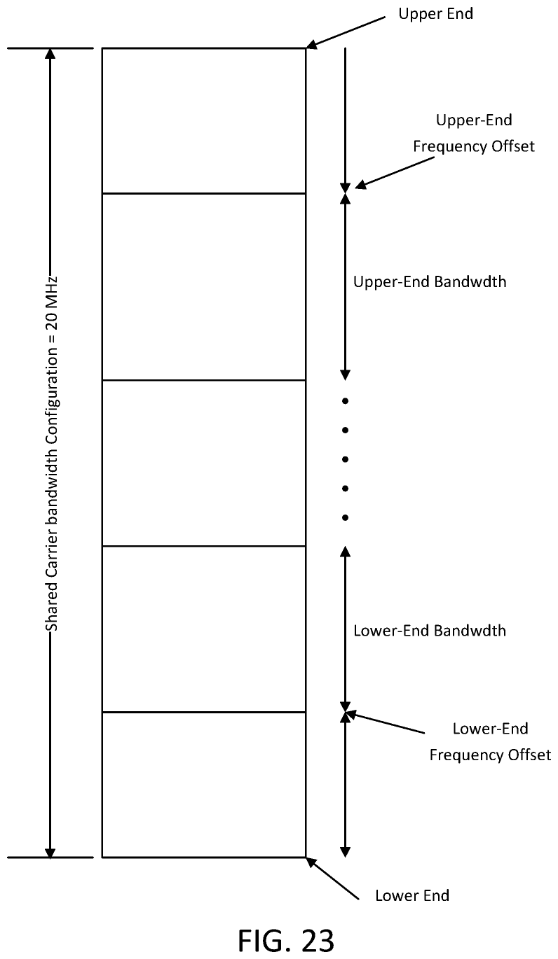

FIG. 23 illustrates configuration parameters in frequency domain. For each resource type (e.g., NR PUCCH resource type), the UE may be configured with one or more of the following parameters by the gNB:
Upper-end Frequency Offset;
Upper-end bandwidth;
Lower-end Frequency Offset; and
Lower-end bandwidth.

The units of the parameters may be expressed in resource block, resource element, resource element group, or any other frequency-time resource grid unit. The resource block, resource element, or resource element group may be defined as in LTE or defined in any other feasible manner.

In another example embodiment, predefined NR resource configurations in frequency domain may be defined by standards. Such predefined configurations may be in function of the frequency bandwidth of the shared carrier, deployment scenarios, supported services, etc. Each predefined configuration may be referenced by an index. The gNB may configure the UE with a predefined NR resource configuration pattern in frequency domain. The gNB may signal to the UE an index that refers to a predefined NR resource configuration in frequency domain. The UE may operate NR on the configured time-frequency resources.

With respect to any of the frequency domain NR resource configuration embodiments described above, the resource allocation in frequency domain may be the same from one time-slot to another, from one subframe to another, or from one frame to another. Alternatively, the NR resource allocation in frequency domain may change at the granularity of mini-slot level, time slot level, subframe level, frame level, or any other defined time scale level.

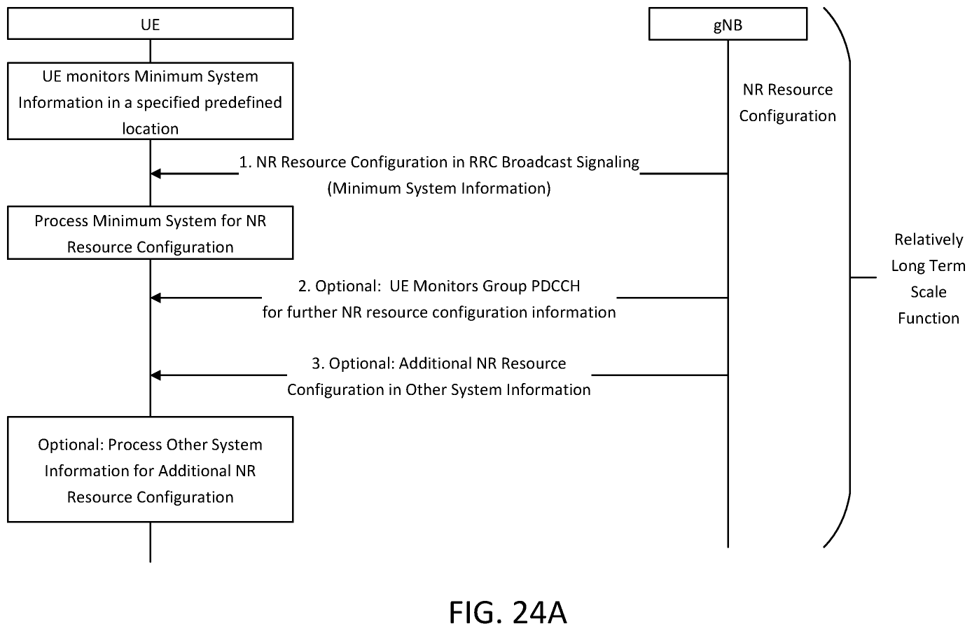

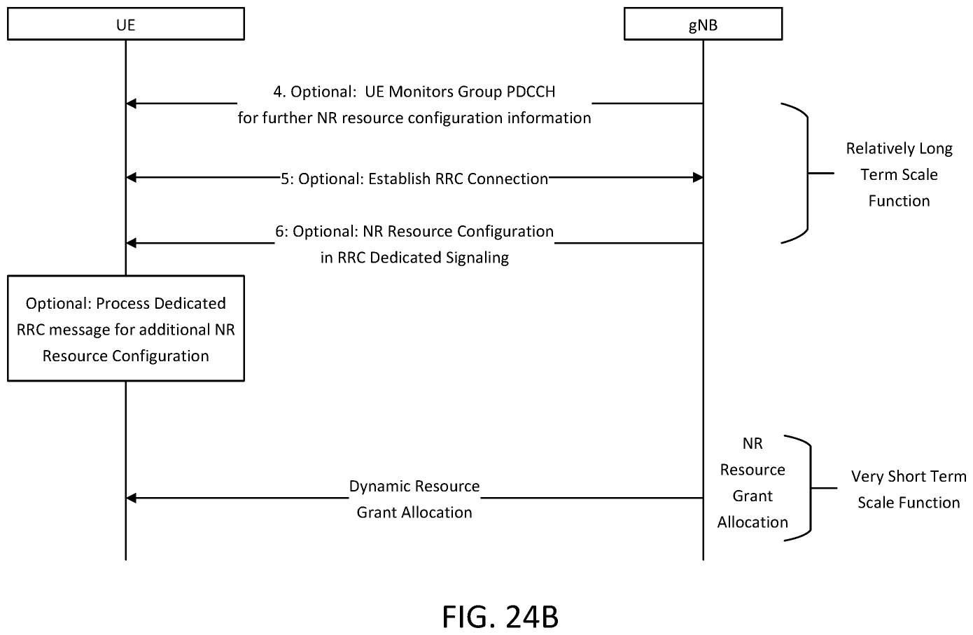

FIG. 24 illustrates a conceptual signaling flow for NR resource configuration. The NR resource configuration aspects may be expected to be a relatively long term time function when compared to a function of dynamic network resources grant to a UE that may operate on a relatively short term time scale. For example, NR reconfiguration may be valid for several radio frames, while resource allocation to a UE or group of UE through dynamic resource grant allocation may be likely to be valid over a much shorter time.

At step 0, the UE may monitor system information in a predefined and specified location in frequency-time NR resource grid. For example, as illustrated in FIG. 19 and FIG. 22, LTE resource grid architecture, the NR SSs resource blocks, and NR PBCH may be located in the six resource blocks that comprise the six center resource blocks in subframe 1 and subframe 6.

At step 1, UE may receive system information from the gNB. The gNB may, for example, include in the Minimum System Information information about NR resource configuration. For example, the minimum system information may include the location of a common PDCCH (CPDCCH) resource used to configure UE with NR resource configuration or a subset of NR resource configuration. In another example, the minimum system information may directly contain NR resource configuration or at least a subset of NR resource configuration.

At step 2, in case the minimum system information does not directly carry the NR resource configuration information, but rather the location of a common PDCCH that may carry the NR resource configuration, the UE may need to monitor the common PDCCH for NR in order to receive NR resource configurations, or at least the subset of the NR resource configurations needed in order to access the system.

At step 3, depending on the NR resource reconfiguration design, it may not be possible to include all of the NR resource configuration information into the minimum system information. In such a case, the UE may receive some of the NR resource configuration information in Other System Information (on NR-PDSCH).

At step 4, similar to Step 2, the other system information may not carry directly the NR resource configuration information, but rather the location of a common PDCCH that carries NR resources configuration. In such a case, the UE may monitor common PDCCH for additional NR resource configurations, i.e., NR resource configurations not required in order to access the system.

At step 5, the UE may establish an RRC connection with the gNB.

At step 6, once the UE established the RRC connection, the UE may receive further NR resource configuration through dedicated RRC signaling.

NR resource configuration signaling information elements may be designed in one or more ways. The elements may be designed via an implicit approach with the use of a resource reservation mechanism. In such an approach, time-frequency resources of an NR carrier that NR UEs cannot use may be signaled to the UE. In other words, the resources in time-frequency resource grids of a carrier that the UE can use are not explicitly communicated to the UE. Upon receiving an NR Resource configuration message (e.g., based on one of the methods described above), the UE may derive the NR time-frequency resources allocation by excluding from the time-frequency resource grid the resources signaled to the UE as reserved resources. In the context of UL carrier sharing between LTE and NR, the gNB may mark reserved resources that the gNB intends to use in order to serve LTE UEs and signal to the NR UEs as part of NR resource configuration that these resources as reserved resources. The elements may be designed via an explicit approach. In such an approach, the gNB may configure NR UEs explicitly with the NR resources on which an NR operation is deployed. The NR UE may consider any other resources from the time-frequency resource grid as not allowed for NR operation. NR resource configuration signaling information elements may also be designed via a combination of the approaches described above.

In example embodiments using MBSFN subframes for NR operation, the network may also configure LTE UEs, radio subframes allocated in support of NR operation, as MBSFN subframes.

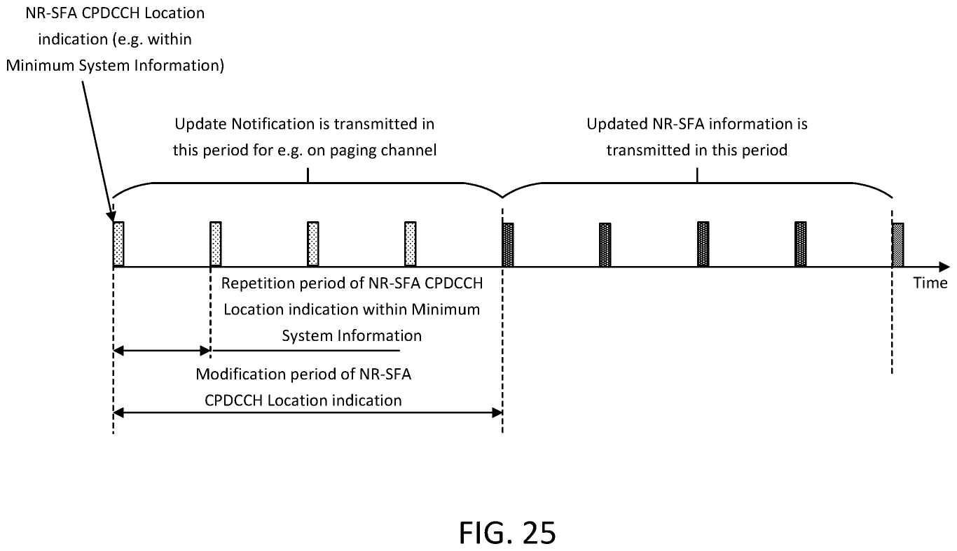

FIG. 25 provides an exemplary embodiment of NR resource configuration through system information broadcast (applicable to minimum system information signaling scenarios or other system information signaling scenarios) where the location in time-frequency resource grid of a common PDCCH carrying NR resource configuration may be indicated to the UE. The system information may also include scheduling information of the common PDCCH. The UE may receive and decode first the common PDCCH in order to know NR resource configuration.

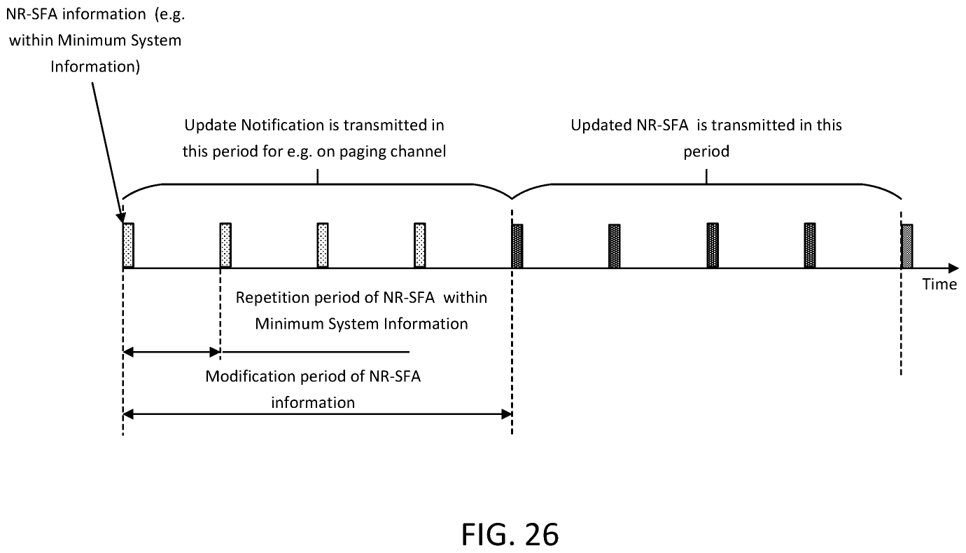

FIG. 26 provides an exemplary embodiment of NR resources configuration through information broadcast (applicable to minimum system information signaling scenarios or other system information signaling scenarios) where the actual NR resource configuration may be directly, i.e., explicitly, included in the system information.

The modification period in either of the example embodiments of FIGS. 25 and 26 may respect the following relation with respect to the System Frame Number SFN: SFN Mod (Modification Period)=frameOffset, where the parameter frameOffset may also be signaled to the UE as part of the NR resource configuration information. The Mod( ) operator may refer to the modulo function. The parameter frameOffset may be an integer and may take the value zero (0). Different values of frame offset may also be defined in the specification and possibly referenced by frame offset indices. The network (e.g., gNB) may then signal the frame offset index to the UE as part of the NR resource configuration information.

If the UE receives a notification of NR resource configuration change in a modification period n-1, then the UE should acquire the updated NR resource configuration in the modification period n.

The UE may also be configured by the gNB with NR resource configuration through dedicated RRC signaling procedures, such as for example, an RRC Connection Reconfiguration procedure with message such as an RRC Connection Reconfiguration message from the gNB to the UE and the RRC Connection Reconfiguration Complete message from the UE to the gNB. Such a procedure may be used to modify, replace, or release existing NR resource configuration at the UE. In an embodiment, the UE may consider the received configuration as immediately active and usable for NR operation upon successful reconfiguration procedure. In another embodiment, the UE may consider a received configuration upon a successful reconfiguration procedure as valid NR resource configuration but not activated. The UE may only use such configuration upon subsequent reception of activation indication of the configuration from the gNB. The gNB may use MAC control element (MAC CE) signaling to activate a previously configured NR resource using a dedicated RRC configuration procedure. In another embodiment, the UE may be configured by the gNB with more than one NR resource configuration set. Furthermore, the network may indicate in the RRC configuration message configuring the UE that some of the NR resources are set as activated while the network within the same RRC message may indicate some of the NR resource configuration are set as not activated. Upon successful completion of such a configuration procedure, the UE may use the NR resource configuration sets indicated as activated by the gNB for NR operation. Similarly, the UE may not use for NR operation those NR resource configuration sets indicated by the gNB as not activated.

As described above with respect to FIGS. 7 and 8, an example embodiment of UL carrier sharing is an embodiment where the NR UE may be configured with two UL carrier C1 (e.g., 1.8 GHz) that can be shared with LTE and C2 (e.g., 3.5 Ghz or higher frequency range, i.e., in the centimeter wave range or millimeter wave range). In one case, the UE may not support simultaneous UL transmission while in the other case, the UE supports simultaneous UL transmission. As illustrated in FIG. 8, the UE may need to decide on UL carrier selection or carrier aggregation for simultaneous UL transmission. Regardless of the UE capability, in idle mode, the UE may need to select an uplink (UL) carrier for UL operation. The UE may use the selected UL carrier for its UL operation including one or more of the following: an initial access procedure, such as for example the random access procedure; and transmission of UL reference signals, such as for example those in support of UL measurement based mobility.

In example embodiments described below, the UE may transmit a UL tracking signal periodically (or aperiodically), based on configuration information received from gNB, e.g., in a system information broadcast. Depending on the procedure applied (e.g., pathloss based, PRACH transmit power based, power headroom based or received UL signal power level or received UL signal quality level), the gNB may perform measurement of the received UL reference signals and use these measurements to estimate one or more of the following quantities below, and provide in its turn, required assistance information such as the following to the UE.

To provide flexibility to the operators, one or more conditions may be specified. The UE may be configured by the network with which condition to use for UL carrier section. The UE may provide assistance information, such as UE capability to the radio access network to help the radio access network (e.g., gNB) decide which UL carrier selection rule the network should configure the UE with. Alternatively, a combination of one or more conditions may be specified and the UE may be mandated to use the specified rule for UL carrier selection, regardless of the UE capability. Examples of one or more conditions may include the following:
UL pathloss target, e.g., PLmax.
Required PRACH transmit power target, e.g., P_{PRACH}max. The UE may calculate P_{PRACH}max based on configuration parameters received from the gNB, e.g., the maximum number of preamble transmission preambleTransMax. In an alternative example, the GNB may configure the UE directly with the value of P_{PRACH}max.
Power head room target (for each UE category or UE power class), e.g., PHmin
UL received signal power level target or UL received signal quality target, e.g., Srxlevmin and Squalmin
Various offset parameters described below.

In an example embodiment, the UE may select a UL carrier and may give equal priority to carriers. The UE may estimate the path-loss for UL carrier C1, denoted PL(C1). The UE may estimate the path loss of UL carrier C2, denoted PL(C2). Path-loss may be expressed in dB. If PL(C2)≤PL(C1), the UE may select UL carrier C2 as the UL carrier. Otherwise, the UE may select UL carrier C1.

The gNB may also explicitly configure the UE with a path-loss offset PLOffset. The PLOffset may be used to account for, for example, preference of one carrier over the other. For example, for NR UEs, the network may configure these UEs to favor the selection of higher frequency carrier C2 over lower frequency carrier C1. The UE may use the configured PLOffset to decide which UL carrier to use for UL operation such as initial access as captured by the inequality rule below.

If PL(C2)≤PL(C1)+PLOffset, the UE may select the UL carrier C2 as the carrier to perform initial access procedure, i.e., random access procedure. Otherwise, the UE may select the UL carrier C1. The parameter PLOffset may be positive or negative and may be expressed in dB units.

For a carrier C, the path-loss may be estimated as follow: PL(C)=referenceSignalPower (C_{DL})−higher layer filtered RSRP (C_{DL})+PLOffsetDLULDelta, where, PLOffsetDLULDelta is an offset to account for potential lack of channel reciprocity between DL and UL. PLOffsetDLULDelta may be positive or negative. The path loss of an uplink carrier may be estimated from that of a DL carrier adjusted with a path loss offset PLOffsetDLULDelta to account for potential inaccuracy of channel reciprocity assumption. The carrier CDL may be any of the downlink carrier of the serving cell of the UE. Alternatively, the carrier CDN may be the closest to the UL carrier C in terms of bandwidth separation between the UL carrier C and the DL carrier CDL. In another alternative example embodiment, for each UL carrier, the network may configure the UE with an associated DL carrier or carriers to be used for the purpose of UL carrier path loss estimation.

In an example embodiment, the UE may select a UL carrier based on PRACH transmit power. For both carrier C1 and C2, the UE may determine the PRACH power that the UE would use should the UE transmit the RACH preamble on that carrier. Let P_{PRACH}(C1) denote the PRACH power in dBm on carrier C1, and P_{RACH}(C2) the P_{RACH} power in dBm on carrier C2.

If P_{PRACH}(C2)≤P_{PRACH}(C1), the UE may select UL carrier C2 as the UL carrier. Otherwise, the UE may select UL carrier C1.

The gNB may also explicitly configure the UE with a PRACH power offset P_{PRACH}Offset. The P_{PRACH}Offset may be used to account for, for example, preference of one carrier over the other. For example, for NR UEs, the network may configure these UEs to favor the selection of higher frequency carrier C2 over lower frequency carrier C1. The UE may use the configured P_{PRACH}Offset to decide which UL carrier to use for UL operation such as initial access as captured by the inequality rule below.

If P_{PRACH}(C2)≤P_{PRACH}(C1)+P_{PRACH}Offset, the UE may select UL carrier C2 as the UL carrier. Otherwise, the UE may select UL carrier C1. The parameter P_{PRACH}Offset may be positive or negative and may be expressed in dB units.

The PRACH transmit power may be set to the initial PRACH transmit power computed as follows: PPRACH(C)=min{P_{CMAX,c}(i), PREAMBLE_RECEIVED_TARGET_POWER(C)+PVC)} where PREAMBLE_RECEIVED_TARGET_POWER=preambleInitialReceivedTargetPower+DELTA_PREAMBLE. P_{CMAX,c}(i) may be the configured maximum UE output power for the UL carrier C for subframe i or time instant i of the UE serving cell, PL(C) may be the downlink path loss estimate calculated in the UE for the UE serving cell. DELTA_PREAMBLE may be the preamble format base offset. The parameter preambleInitialReceivedTargetPower may be the initial preamble power the UE is configured with.

In another embodiment, a carrier specific PRACH load offset P_{PRACH}LoadOffset (in dBm) may be used as per the formula below for P_{PRACH}(C) computation. This P_{PRACH}LoadOffset may be signaled to the UE by the gNB. Alternatively, the UE may autonomously estimate the value of P_{PRACH}LoadOffset, for example, based on past power ramp-up history. P_{PRACH}(C)=min{P_{CMAX,c}(i), PREAMBLE_RECEIVED_TARGET_POWER(C)+PL(C)} where PREAMBLE_RECEIVED_TARGET_POWER=preambleInitialReceivedTargetPower+DELTA_PREAMBLE+P_{PRACH}LoadOffset.

In an example embodiment, the UE may select a UL carrier based on UL power headroom. The UE may use power headroom to select the UL carrier for initial access as follows. If PH(C2)≥PH(C1), the UE may select UL carrier C2 as the carrier to perform UL operation such as initial access for, for example, random access procedure. Otherwise, the UE may select UL carrier C1 as a UL carrier.

The gNB may also explicitly configure the UE with a power headroom offset PHOffset. The PHOffset may be used to account for, for example, preference of one carrier over the other. For example, for NR UEs, the network may configure these UEs to favor the selection of higher frequency carrier C2 over lower frequency carrier C1. The UE uses the configured PHOffset to decide on which UL carrier to use for initial access as captured by the inequality rule below.

If PH(C2)+PHOffset≥PH(C1), the UE may select UL carrier C2 as the carrier for UL operation such as initial access for, for example, random access procedure. Otherwise, the UE may select UL carrier C1. The parameter PHOffset may be positive or negative and may be expressed in dB units.

The power headroom PH(C) of a carrier C may be computed as follows: PH(C)=P_{CMAX,c}(i)−P_{PRACH}(C)−Pₒₜₕₑᵣ(C), where P_{CMAC,c}(i) may be the configured maximum UE output power for the UL carrier C for subframe i or time instant i of the UE serving cell. Pₒₜₕₑᵣ(C) may be the transmit power on UL carrier C for subframe i or time instant i as the result from all other transmissions that may be sharing hardware components (e.g., power amplifier) on carrier C, e.g., Wi-Fi transmission.

In an example embodiment, the UE may select a UL carrier based on UL Srxlev and UL Squal. In such an example, a UL carrier selection criteria similar to LTE DL cell selection criterion S is defined. Let criteria S_{UL.}Srxlev denote the UL signal received level at the gNB and Squal(C) denote the UL signal received quality at the gNB. Such criteria may denote the received power or the received quality of a signal or channel at the gNB for a given transmit power of a given signal or a given channel at the UE. To assist the gNB in determining the target received power at gNB and/or the target received quality at the gNB, the UE may transmit a signal or a channel with a transmit power level known to the gNB. In an example embodiment, the assumed transmitted signal at the UE may be a UL tracking reference signal similar to or the same as the UL reference signal being designed by 3GPP in support of UL based mobility. In another example embodiment, the signal may be a UL sounding reference signal. In another example embodiment, the assumed transmitted channel at the UE may be the Physical Random Access Channel (PRACH). The UE may receive the configuration of the UL tracking signal or the UL sounding reference signal, including resources in frequency and time as well as time period or intervals on which to transmit such signal in system information broadcast. The UE transmission of the UL sounding reference signal or the sounding reference signal, may be configured as periodic UL transmission or aperiodic. Similarly, the UE may be configured by the gNB with PRACH resources configuration, including, for example, specific preambles and time-frequency domain resource configuration. The gNB may broadcast to the UE thresholds on minimum uplink required Rx level (minimum RSRP) in the cell and the minimum uplink required quality level (Minimum RSRQ) in the cell. Let these thresholds be denoted as Qrxlevmin, and Qqualmin respectively. The gNB may broadcast multiple thresholds for each quality metric; for each quality metric (RSRP or RSRQ), there may be one threshold per UE power class or per UE maximum configured power output per carrier, P_{CMAX,c}.

The UE may use one of the following rules for the initial carrier selection.

If Srxlev(C2)≥Srxlev(C1), the UE may select UL carrier C2 as the carrier for UL operation, such as initial access procedure for, for example, random access procedure. Otherwise, the UE may select UL carrier C1 for its UL operation;

If Squal(C2)≥Squal(C1), the UE may select UL carrier C2 as the carrier for UL operation, such as initial access procedure for, for example, random access procedure. Otherwise, the UE may select UL carrier C1 for its UL operation; and

If Srxlev(C2)≥Srxlev(C1) and Squal(C2)≥Squal(C1), the UE may select UL carrier C2 as the carrier for UL operation, such as initial access procedure for, for example, random access procedure. Otherwise, the UE may select UL carrier C1 for its UL operation.

Similar to other described example embodiments, the gNB may also explicitly configure the UE with SrxlevOffset (in dB) or SqualOffset (in dB). These offset may be used by the UE to account for, for example, preference of one carrier over the other. For example, for NR UEs, the network may configure these UEs to favor the selection of higher frequency carrier C2 over lower frequency carrier C1. The UE may use the configured SrxlevOffset or SqualOffset to decide which UL carrier to use for initial access as captured by the inequality rule below. For example, the conditions above may be reformulated as follows. SrxlevOffset or SqualOffset may take positive or negative values.

If Srxlev(C2)+SrxlevOffset≥Srxlev(C1), the UE may select UL carrier C2 as the carrier for UL operation, such as initial access procedure for, for example, random access procedure. Otherwise, the UE may select UL carrier C1 for its UL operation.

If Squal(C2)+SqualOffset≥Squal(C1), the UE may select UL carrier C2 as the carrier for UL operation, such as initial access procedure for, for example, random access procedure. Otherwise, the UE may select UL carrier C1 for its UL operation.

If Srxlev(C2)+SrxlevOffset≥Srxlev(C1) and Squal(C2)+SqualOffse≥Squal(C1 the UE may select UL carrier C2 as the carrier for UL operation, such as initial access procedure for, for example, random access procedure. Otherwise, the UE may select UL carrier C1 for its UL operation.

Srxlev may be the UL signal received level at the gNB and Squal(C) may be the UL signal received quality at the gNB. Srxlev for a carrier C may be computed as follows: Srxlev(C)=Qrxlevmeas(C)−Qrxlevmin(C). Similarly, Squal for a carrier C may be computed as follows: Squal(C)=Qqualmeas(C) Qqualmin(C). Qrxlevmeas (C) may refer to the UE estimation of the measured RX level (RSRP) on carrier C at the gNB. Such estimate could be based on the measured RSRP in downlink on the serving cell plus compensation for potential lack of channel reciprocity. Qqualmeas (C) may refer to the UE estimation of the measured quality level (RSRQ) on carrier C at the gNB. Such estimate could be based on the measured RSRQ in downlink on the serving cell plus compensation for potential lack of channel reciprocity.

The gNB may configure the UE with carrier specific offset Qoffset to be used by the UE for the evaluation of the Srxlev or Squal. The gNB may also configure the UE with other offset to account for various deployment scenario or measurements conditions. The offsets may be common to both Srxlev and Squal evaluation. As an illustration of the use of Qoffset, Srxlev(C) may be computed as Srxlev(C)=Qrxlevmeas(C)−Qrxlevmin(C)−Qoffset while Squal may be computed as Squal(C)−Qqualmeas(C)−Qqualmin(C)−Qoffset. Both Srxlev and Squal may also be computed in an identical way as currently computed in LTE.

In example embodiments, the UE may also use the following criteria alone or in combination with one or more of the equal priority UL carrier selection methods described above.
Latency: for example, the UE supporting multiple numerology services may select the UL carrier with shorter latency. For example, the UE may be configured with latency information for the configured UL carriers. For example, the UE may be configured for each carrier, one or more numerologies the UE is allowed to use on a given UL carrier. The UE may then make the determination of transmission latency or latencies the UE may expect on a given UL carrier, based on numerologies associated with the UL carrier, and other attributes such as the service the UE intends to request or use once connected to the network. The UE may also autonomously determine what latency to expect on a given UL carrier. In another embodiment, the UE may select the UL carrier with the longer latency.
Available bandwidth: for example the UE supporting dynamic bandwidth switching may select the carrier with the higher bandwidth. In another embodiment, the UE may select the carrier with the smaller bandwidth.
Expected data rate: for example the UE may select the carrier with the highest expected data rate for, for example, the highest estimated data rate.
Reliability requirements: for example the UE supporting simultaneous eMBB and URLLC services may select the UL carrier under the condition that the selected UL carrier meet certain reliability requirement.
Speed: the UL carrier selection may be speed dependent. For example, the UE may be configured with two or more speed ranges, and for each speed range, the UE may be configured with one or more allowed UL carrier for that speed range. The UE may only select the UL carriers allowed for the speed range that corresponds to the anticipated UE speed range. When more than one UL carriers are allowed for the UE speed range, the UE may use one of the methods described above for equal priority UL carrier selection. In another alternative, the UE may apply a speed related scaling factor for each of the methods described above, i.e., the path loss based method, the PRACH transmit power based method, the power headroom based method or the UL received power or UL received quality based approach. For example, the following scaling factor may apply:
   UL Path-loss Comparison based: the condition “If PL(C2)≤PL(C1)|PLOffset” discussed above may become “If PL(C2)≤PL(C1)+PLOffset+PLOffsetSpeed” where PLOffsetSpeed may be a speed scaling factor for the pathloss based UL carrier selection rule. PLoffsetSpeed maybe positive or negative.
   PRACH transmit power based approach: the condition “If P_{PRACH}(C2)≤P_{PRACH}(C1)−P_{PRACH}Offset” discussed above may become “If P_{PRACH}(C2)≤P_{PRACH}(C1)−P_{PRACH}Offset+P_{PRACH}OffsetSpeed” where PLoffsetSpeed may be a speed scaling factor for the PRACH transmit power based UL carrier selection rule.
   UL Power headroom based approach: the condition “If PH(C2)−PHOffset≥PH(C1)” discussed above may become “If PH(C2)+PHOffset+PHOffsetSpeed≥PH(C1)” where PHOffsetSpeed may be a speed scaling factor for the power headroom based UL carrier selection rule.
   UL Srxlev and UL Squal based approach: the condition “If Srxlev(C2)+SrxlevOffset≥Srxlev(C1)” discussed above may become “If Srxlev(C2)+SrxlevOffset+SrxlevOffsetSpeed≥Srxlev(C1)”, the condition “If Squal(C2)+SqualOffset≥Squal(C1)” may become “Squal(C2)+SqualOffset+SqualOffsetSpeed≥Squal(C1)”, and the condition “If Srxlev(C2)+SrxlevOffset≥Srxlev(C1) and Squal(C2)+SqualOffset≥Squal(C1” may become “If Srxlev(C2)+SrxlevOffset+SrxlevOffsetSpeed≥Srxlev(C1) and Squal(C2)+SqualOffset+SqualOffsetSpeed≥Squal(C1” where SrxlevOffsetSpeed and SqualOffsetSpeed may be speed scaling factors for the UL RX power and UL RX quality based UL carrier selection rule.

In example embodiments, the UE may select a UL carrier and may give unequal priority to carriers. The gNB may configure the UE with assistance information such as UL carrier priority levels (absolute priority or relative priority) between UL carriers in addition to received signal quality metric or transmit signal (e.g., PRACH) power level related thresholds. The priorities can be common or individual, i.e., dedicated priorities. Common priorities may be broadcast while individual priorities which may be user specific and may be used to provide differentiated service specific or user specific initial access. They may be signaled to the UE through dedicated signaling. An advantage of such embodiments is that the UE can avoid unnecessary measurements of lower priority carriers subject to specified measurements conditions. The UE may try to perform initial access on the highest priority carrier frequency. The UE may measure and possibly try to perform initial access on the lower priority frequency in cases when higher priority UL frequency quality is too low.

In an example embodiment, absolute priorities of different NR UL frequencies or inter-RAT UL frequencies may be provided to the UE in the system information, in the RRC Connection Release message, or by inheriting from another RAT at inter-RAT cell (re)selection. In the case of system information, an NR frequency or inter-RAT frequency may be listed without providing a priority (i.e., UL Carrier Selection Priority may be absent for that frequency). If priorities are provided in dedicated signaling, the UE may ignore the priorities provided in system information. If UE is in camped on any cell state, UE may only apply the priorities provided by system information from the current cell, and the UE may preserve priorities provided by dedicated signalling including priorities received from the gNB in RRC Connection Reject message. The terminology “camped on any cell” state is used herein with the same meaning or similar meaning as defined for LTE Idle mode operation, (TS 36.304). For example, when the UE finds no suitable cell, the UE may select an acceptable cell, camp on that cell and then enter into “camped on any cell” state.

When the UE in camped normally state has only dedicated UL carrier priorities other than for the current cell UL frequencies (being broadcasted for example by the current serving cell, the UE may consider the current UL frequencies to be the highest priority frequency (i.e., higher than any of the network configured values).

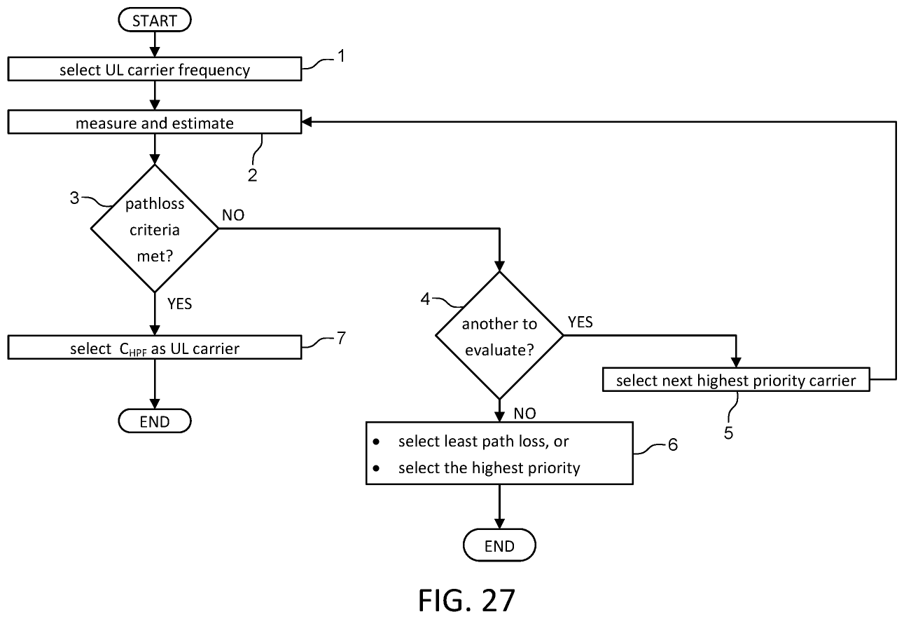

A UE may select a UL carrier based on absolute priority, using a path-loss based selection, as illustrated in the example of FIG. 27.

In step 1 of FIG. 27, the UE selects the highest priority UL carrier frequency and set the variable C_{HPF} to the selected carrier frequency.

In step 2, the UE performs measurements on C_{HPF} and estimate the path loss PL(C_{HPF}) on C_{HPF}.

At step 3, if PL(C_{HPF})<PLmax, then in step 7 the UE may select UL carrier C_{HPF} as the carrier for UL operations such as initial access procedure. PLmax may be the maximum path loss threshold the UE is configured with by the gNB.

If, at step 3, if PL(C_{HPF}) is not <PLmax, then in at step 4 the UE checks whether there is another carrier to evaluate. If so, in step 5, the UE may select the next highest priority carrier frequency and set the variable C_{HPF} to the selected carrier frequency.

After step 5, the UE repeat steps 2 through 4 as needed.

If in step 4 there is not another carrier to evaluate, then the UE may respond in a number of ways in step 6. The UE may select the carrier frequency with the least path loss PL(C_{HPF}). In case of tie, for example, the UE may select the highest priority carrier for UL operations. Alternatively in step 6, the UE may select the highest priority carrier.

For a carrier C, the long-term path-loss may be estimated as describe above, i.e., as follows: PL(C)−referenceSignalPower (C)−higher layer filtered RSRP (C). The network may also configure the UE with various offsets to account for many factors that might affects the UE pathloss estimation such as channel reciprocity, deployment scenarios, measurements assumptions, etc. For example, if the shared UL carrier frequency C1 is a low frequency range carrier (for example 1.8 GHz) while the DL carrier C3 is higher frequency range carrier (e.g., 3.5 GHz or higher), the gNB might configure the UE with a pathloss offset PLOffsetDLULDelta to account for the fact that UL and DL channels are not reciprocal. For example, in such a case, the UE may compute the pathloss PL(C) as (referenceSignalPower (C)−higher layer filtered RSRP (C))+PLOffsetDLULDelta.

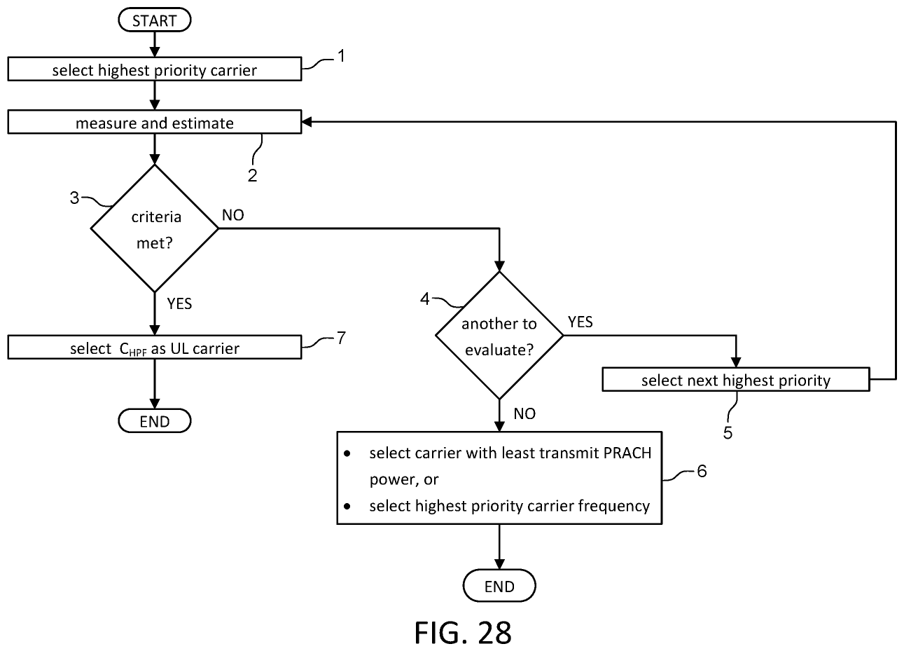

The UE may select a UL carrier based on absolute priority, using a PRACH transmit power based selection. FIG. 28 is a flow diagram illustrating such a procedure. PRACH transmit power may be computed as per one of the P_{PRACH} computation approaches described above.

In step 1 of FIG. 28, the UE selects the highest priority UL carrier frequency and set the variable C_{HPF} to the selected carrier frequency.

In step 2, the UE performs measurements on C_{HPF} and estimates the PRACH transmit power P_{PRACH} of C_{HPF}.

In step 3, if P_{PRACH}(C_{HPF})<P_{PRACH}max, then in step 7 UE may select UL carrier C_{HPF} as the carrier for UL operations such as initial access procedure. P_{PRACH}max may be the maximum PRACH transmit power threshold the UE is configured with by the gNB. The UE may also calculate P_{PRACH}max based on configuration parameters received from the gNB for, for example, the maximum number of preamble transmission preambleTransMax.

If, in step 3, P_{PRACH}(C_{HPF}) is not <P_{PRACH}max, then in step 4, the UE may check whether there is another carrier to evaluate. If there is another to evaluate, then in step 5 the UE may select the next highest priority carrier frequency and set the variable C_{HPF} to the selected carrier frequency.

After step 5, the UE may repeat steps 2 through 4 as needed.

If in step 4 there is no other carrier to evaluate, then in step 6 the UE may respond in a number of ways. For example, the UE may select the carrier frequency with the least transmit PRACH power P_{PRACH}(C_{HPF}). In case of tie, the UE may select the highest priority carrier for initial access. Alternatively in step 6, the UE may select the highest priority carrier.

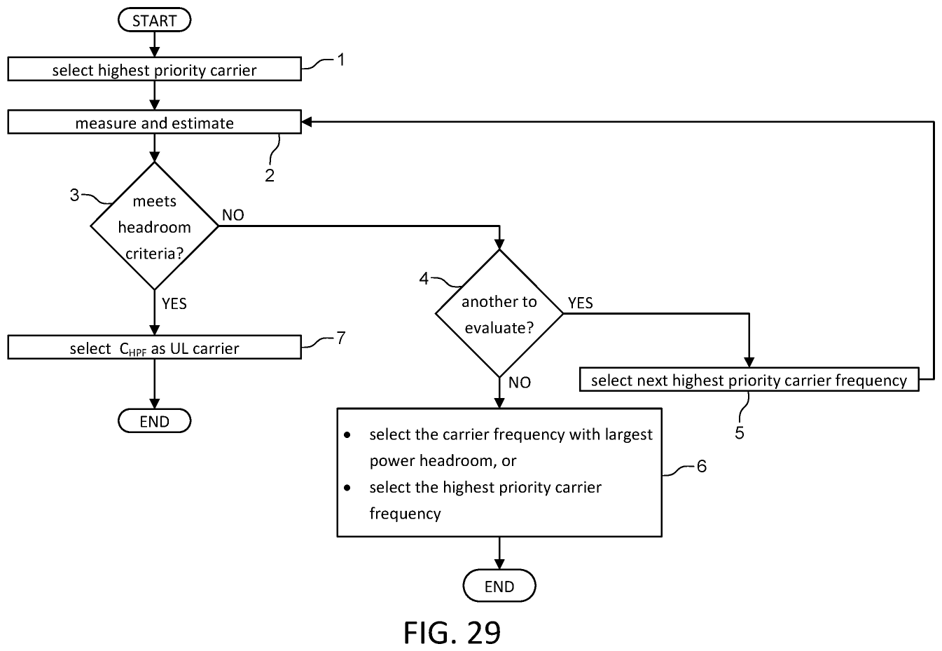

In example embodiments, the UE may select a UL carrier based on absolute priority, using a power head room based selection. FIG. 29 is a flow diagram illustrating such a procedure. The power headroom may be estimated as described above.

In step 1 of FIG. 29, the UE selects the highest priority UL carrier frequency and set the variable C_{HPF} to the selected carrier frequency.

In step 2, the UE performs measurements on C_{HPF} and estimates the power headroom associated with C_{HPF}, PH(C_{HPF}).

In step 3, if PH(C_{HPF})>PHmin, a headroom power criteria, then in step 7 the UE may select UL carrier C_{HPF} as the carrier for UL operations such as initial access procedure. PHmin may be the minimum power headroom threshold the UE is configured with by the gNB.

If, in step 3, PH(C_{HPF}) is not >PHmin, then in step 4, the UE may check whether another carrier frequency is available to evaluate. If so, in step 5, the UE may select the next highest priority carrier frequency and set the variable C_{HPF} to the selected carrier frequency.

After step 5, the UE may repeat steps 2 through 4 as needed.

If in step 4 there is not another carrier to evaluate, e.g., the UE fails to select a UL carrier, then in step 6 the UE may respond in a number of ways. For example, the UE may select the carrier frequency with the largest power headroom PH(C_{HPF}). In case of tie, the UE may select the highest priority carrier for initial access. Alternatively in step 6, the UE may select the highest priority carrier.

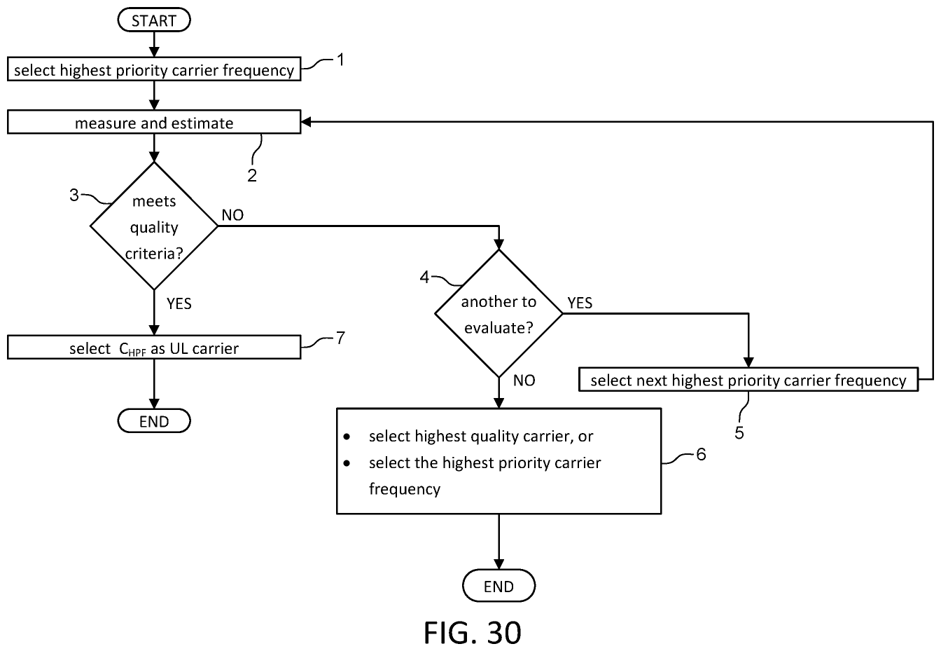

In example embodiments, the UE may select a UL carrier based on absolute priority, using a UL Srxlev and UL Squal based selection. FIG. 30 is a flow diagram illustrating such a procedure. Srxlev and Squal may be computed as described above.

In step 1 of FIG. 30, the UE selects the highest priority UL carrier frequency and set the variable C_{HPF} to the selected carrier frequency.

In step 2, the UE performs measurements on C_{HPF} and estimates the quality of the carrier C_{HPF}, Q(C_{HPF}).

At step 3, if the quality Q(C_{HPF}) of the high priority carrier meets the specified quality criteria, then in step 7 the UE may select UL carrier C_{HPF} as the carrier for UL operations such as initial access procedure.

Otherwise, in step 4, the UE checks whether there is another carrier frequency to evaluate. If so, then in step 5, the UE may select the next highest priority carrier frequency and set the variable C_{HPF} to the selected carrier frequency.

After step 5, the UE may repeat steps 2 through 4 as needed.

If in step 4 there is not another carrier to evaluate, e.g., the UE fails to select a UL carrier, then in step 6 the UE may respond in a number of ways. The UE may select the carrier frequency with the higher quality among the considered UL carriers. In case of tie, the UE may select the highest priority carrier for initial access. Alternatively in step 6, the UE may select the highest priority carrier.

In example embodiments, quality criteria may be defined as one of the following:
Q(C_{HPF}) is defined as Srxlev(C_{HPF}). The quality criteria in step 3 can then be specified as follows: Squal(C_{HPF})>0
Q(C_{HPF}) is defined as Squal(C_{HPF}). The quality criteria in step 3 can then be specified as follows: Squal(C_{HPF})>0
Q(C_{HPF}) is defined by two components i.e. Srxlev(C_{HPF}) and Squal(C_{HPF}). The quality criteria in step 3 can then be specified as follows: Squal(C_{HPF})>0 and Squal(C_{HPF})>0.

In example embodiments, the UE may select a UL carrier while in inactive mode. The UE controlled based embodiments described for RRC idle mode may also apply to RRC Inactive Mode.

In example embodiments, the UE may select a UL carrier while RRC connected. For RRC connected UEs, network controlled based embodiments may apply akin in handover. The network may control directly what UL carrier the UE should use for UL operation. The network may signal to the UE through dedicated signaling which UL carrier to use. To assist the network decision, the UE may provide assistance information to the gNB. The gNB may use the UE assistance information to decide UL carrier selection. The gNB may use any of the methods described above to select an UL frequency. The UE may transmit periodically (or aperiodically), based on configuration information received from gNB, e.g., in system information broadcast, a UL reference signal. Depending on the procedure applied (e.g., pathloss based, PRACH transmit power based, power headroom based, or received UL signal power level or received UL signal quality level), the gNB may perform measurement of the received UL reference signals and use these measurements to estimate or more of the following quantities: UL pathloss; required PRACH transmit power; power head room (for each UE category or UE power class); and/or UL received signal power level or UL received signal quality.

The gNB may use one or more of the above metrics to decide on which UL carrier to use. The network may also base its decision on the subscriber profile, e.g., platinum user versus gold user versus silver user versus bronze user, or the Subscriber Profile ID (SPID) configured within the network.

The network may send a command to the UE which may include the selected UL carrier information, possibly target beam information for initial access on the selected UL carrier, initial resource grant information including TX power information, and/or timing advance group configuration. For example, the gNB may configure the UE with the timing advance group DL carrier(s) to be used as for the time reference in derivation of the UL timing.

In an example embodiment, the gNB may signal the UL carrier selection information to the UE using RRC dedicated signaling, for example through a reconfiguration procedure (e.g., RRC Connection Reconfiguration message from gNB and RRC Connection Reconfiguration complete message from UE in the case of a successful reconfiguration). In a related embodiment, when the UE receives UL carrier selection information, the UE may consider the received message as a command message to be immediately executed, i.e., no further activation comment may be required from the gNB and the UE can start using the indicated UL carrier for UL operations. In another example embodiment, after a successful reconfiguration procedure, an UL carrier activation should be performed before the UE may use the configured UL carrier for uplink operations. The gNB may indicate to the UE to start using an already configured UL carrier for UL operations either through RRC dedicated signaling or MAC Control Element signaling. The configuration of UL carrier and activation of UL carrier may also be performed as part of the same procedure, e.g., RRC Connection reconfiguration procedure. For example, the gNB may signal to the UE as part of the RRC Connection reconfiguration procedure, within the same RRC message (e.g., RRC Connection reconfiguration message), the configuration information of an UL carrier together the activation status of the UL carrier, i.e., whether or not from the network perspective, the UL carrier is considered activated.

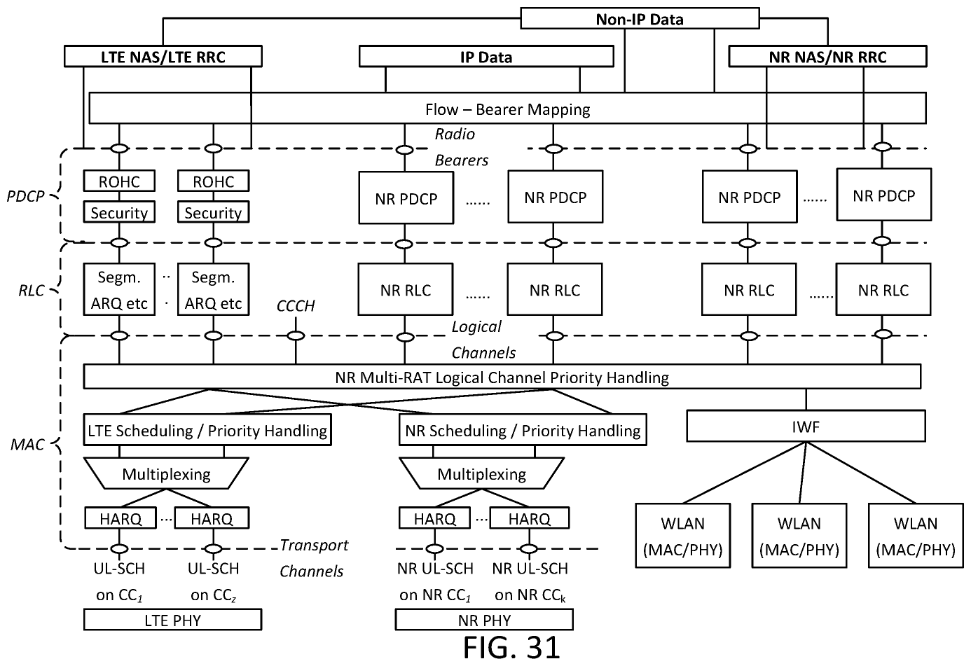

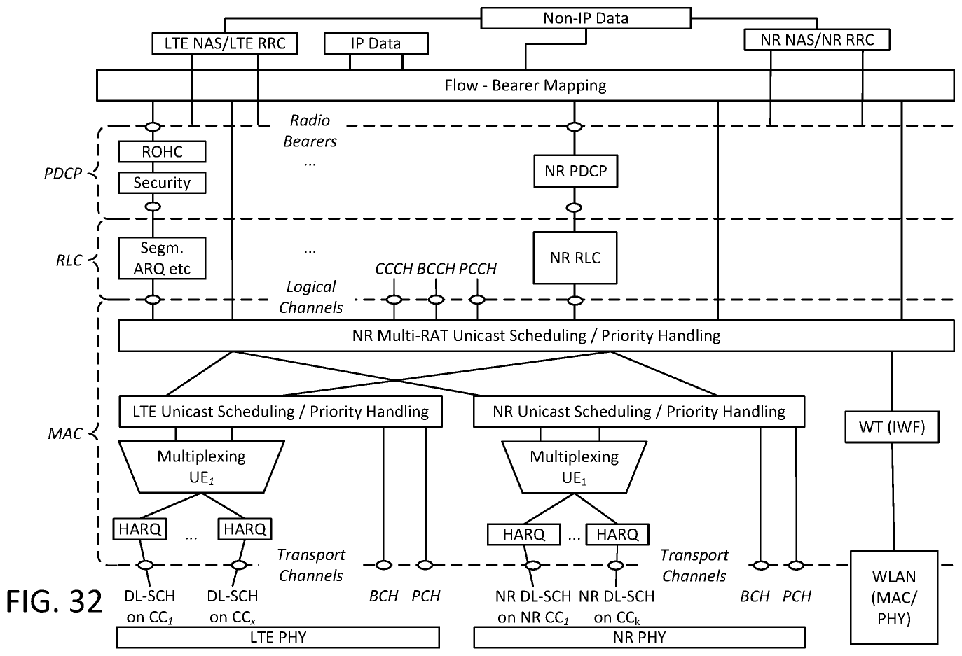

Example embodiments may use a Multi-RAT MAC level carrier aggregation model. FIG. 31 illustrates a MAC level UL Multi-RAT carrier aggregation model from a UE perspective, and FIG. 32 illustrates a MAC level UL Multi-RAT carrier aggregation model from a gNB perspective. The Non-IP data packet may be encapsulated into NAS PDU for transmission. In an alternative example embodiment, the Non-IP data packet may use the service of the Flow and bearer mapping protocol entity, referred to herein as a Service Data Adaptation Protocol (SDAP). Similarly, an IP data packet may be encapsulated into NAS PDU for transmission. In an alternative example embodiment, the IP data may use the service of the SDAP protocol. The LTE NAS, LTE RRC, NR NAS and NR RRC protocols may not use the service of the SDAP protocol. LTE NAS PDU, LTE RRC PDU, NR NAS PDU and NR RRC PDU may use the service of PDCP, i.e., these PDUs may be SDUs of PDCP. Some NR Signaling Radio Bears (SRB) may use the service of PDCP for, for example, the functionality of ROHC (RObust Header Compression) while some other NR SRBs may not use that service. For example, NR SRB1 and SRB2 may use the service of PDCP and RLC and the protocol sublayers beneath them. Further, signaling radio bearer such as SRB0 mapped for, for example, the CCCH (Common Control CHannel) may not use PDCP service and may not use RLC services, or equivalently may use transparent mode RLC.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to affect the methods described herein. As used herein, the terms “apparatus,” “network apparatus,” “node,” “entity”, “function,” “device,” and “network node” may be used interchangeably, without limitation unless otherwise specified.

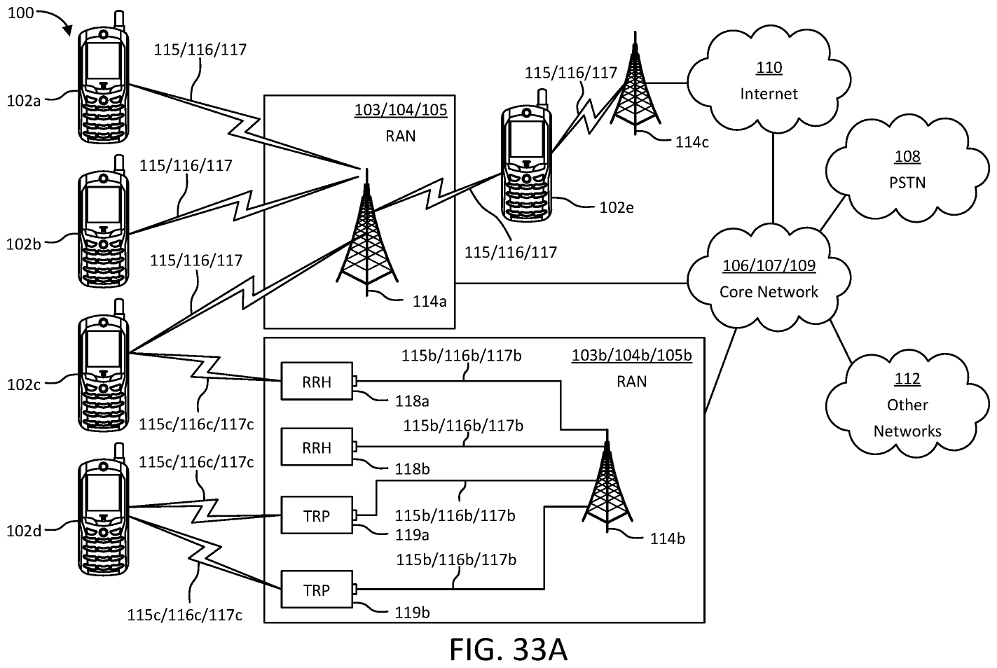

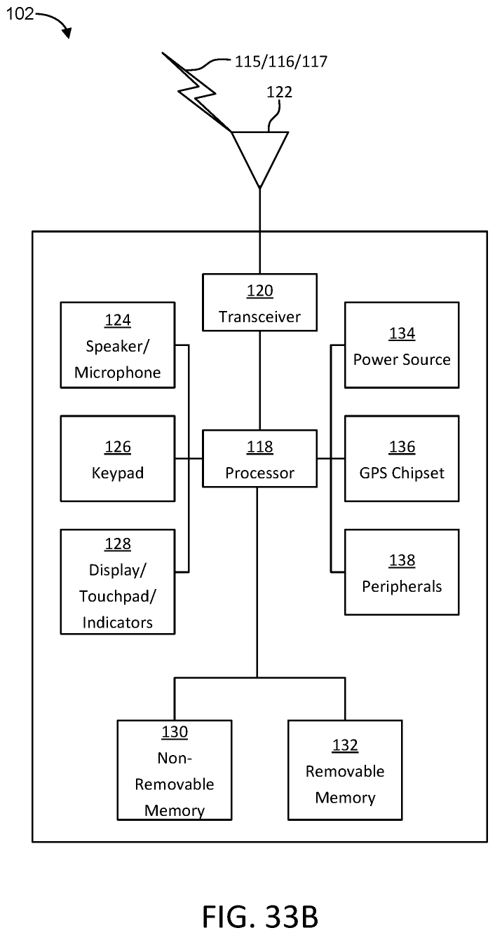

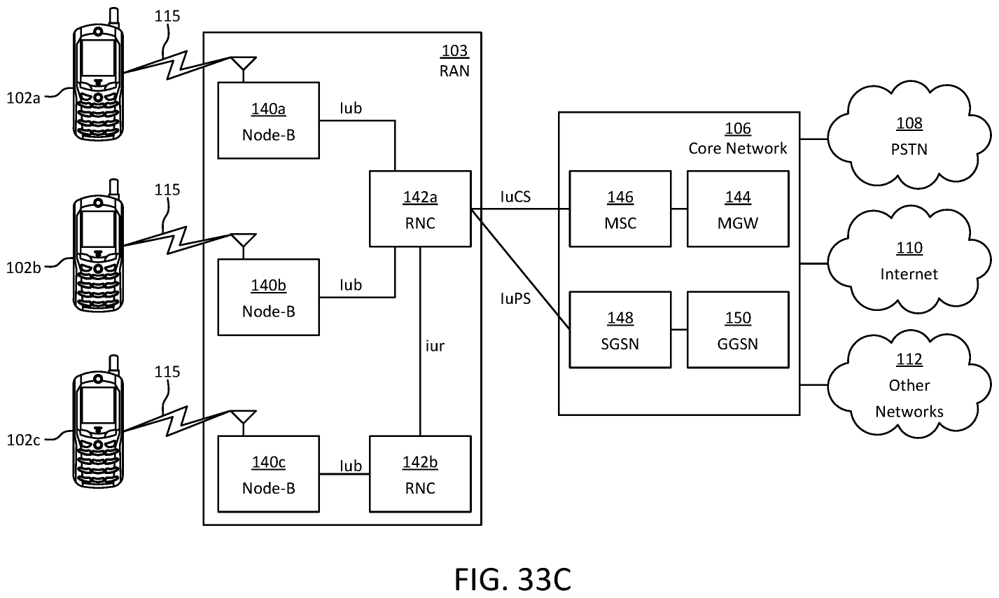

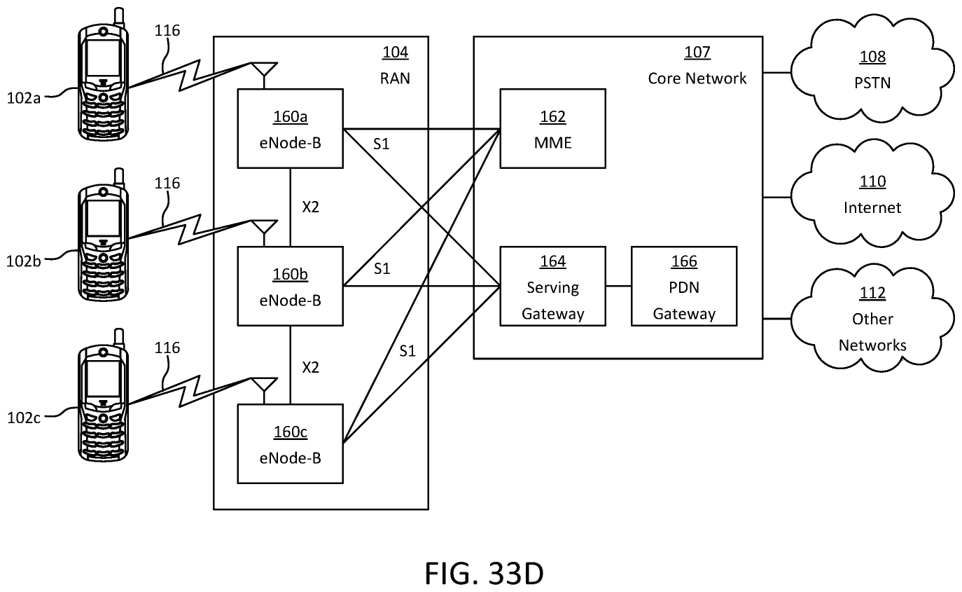

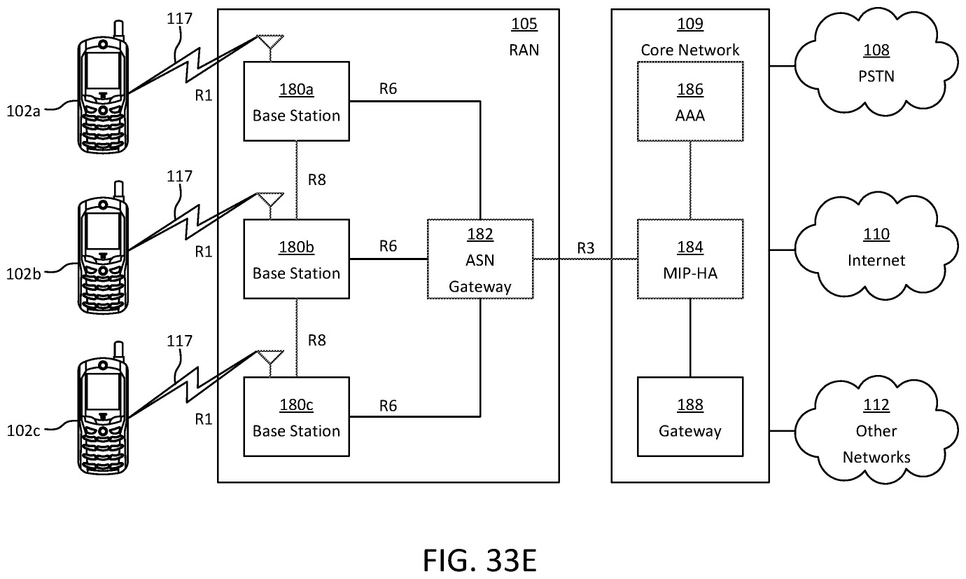

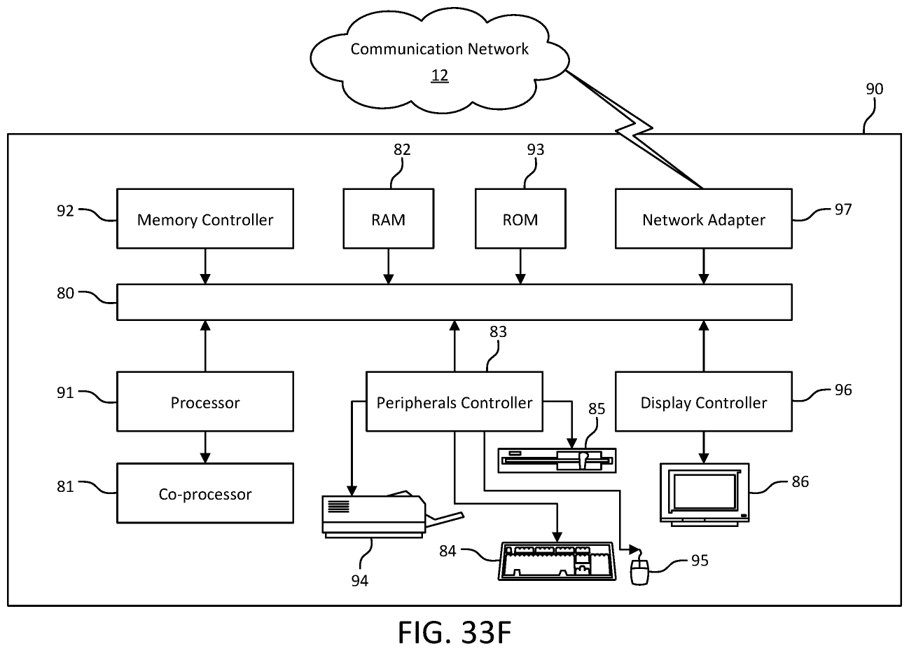

It is understood that the nodes performing the steps illustrated, for example, in FIGS. 3 to 32, may be logical entities that may be implemented in the form of software (i.e., computer-executable instructions) stored in a memory of, and executing on a processor of, an apparatus configured for wireless and/or network communications or a computer system such as those illustrated in FIGS. 33B and F. That is, the method(s) illustrated in FIGS. 3 to 32 may be implemented in the form of software (i.e., computer-executable instructions) stored in a memory of an apparatus, such as the apparatus or computer system illustrated in FIGS. 33B and F, which computer executable instructions, when executed by a processor of the apparatus, perform the steps illustrated in FIGS. 3 to 32. It is also understood that any transmitting and receiving steps illustrated in FIGS. 3 to 32 may be performed by communication circuitry of the apparatus under control of the processor of the apparatus and the computer-executable instructions (e.g., software) that it executes.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that can be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

It will be understood that for different RAN architectures, the grant-less UL control and management described above may be conducted at an NR-node, Transmission and Reception Point (TRP), Remote Radio Head (RRH), or the like, as well as the central controller in RAN or the control function in a RAN slice. Embodiments described herein may also be applicable to TRP, RRH, central controller, and control function in different RAN architectures.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+ Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

FIG. 33A illustrates one embodiment of an example communications system 100 in which the methods and apparatuses described and claimed herein may be embodied. As shown, the example communications system 100 may include wireless transmit/receive units (WTRUs) 102a, 102b, 102c, and/or 102d (which generally or collectively may be referred to as WTRU 102), a radio access network (RAN) 103/104/105/103b/104b/105b, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d, 102e may be any type of apparatus or device configured to operate and/or communicate in a wireless environment. Although each WTRU 102a, 102b, 102c, 102d, 102e is depicted in FIGS. 33A-33E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b and/or TRPs (Transmission and Reception Points) 119a, 119b to facilitate access to one or more communication networks, such as the core network 106/107/109, the Internet 110, and/or the other networks 112. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b and/or TRPs 119a, 119b over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b and/or TRPs 119a, 119b may communicate with one or more of the WTRUs 102c, 102d over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b and TRPS 119a, 119b in the RAN 103b/104b/105b and the WTRUs 102c, 102d, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a in the RAN 103/104/105 and the WTRUs 102a, 102b, 102c, or RRHs 118a, 118b and TRPS 119a, 119b in the RAN 103b/104b/105b and the WTRUs 102c, 102d, may implement a radio technology such as Evolved UMTS Terrestrial Radio Access (E-UTRA), which may establish the air interface 115/116/117 using Long Term Evolution (LTE) and/or LTE-Advanced (LTE-A). In the future, the air interface 115/116/117 may implement 3GPP NR technology.

In an embodiment, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 33A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e may implement a radio technology such as IEEE 802.11 to establish a wireless local area network (WLAN). In an embodiment, the base station 114c and the WTRUs 102e may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 33A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 33A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 33A may be configured to communicate with the base station 114a, which may employ a cellular-based radio technology, and with the base station 114c, which may employ an IEEE 802 radio technology.

FIG. 33B is a block diagram of an example apparatus or device configured for wireless communications in accordance with the embodiments illustrated herein, such as for example, a WTRU 102. As shown in FIG. 33B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 33B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 33B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive Although not shown in FIG. 33A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, and 102d may include multiple transceivers for communicating with different wireless networks over different wireless links. For example, the WTRU 102c shown in FIG. 33A may be configured to communicate with the base station 114a, which may employ a cellular-based radio technology, and with the base station 114b, which may employ an IEEE 802 radio technology.

FIG. 33B is a block diagram of an example apparatus or device configured for wireless communications in accordance with the embodiments illustrated herein, such as for example, a WTRU 102. As shown in FIG. 33B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 33B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 33B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 33B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 33C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 33C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 33C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 33C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 33D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 33D, the eNode-Bs 160a, 160b, 160c may communicate with one another over an X2 interface.

The core network 107 shown in FIG. 33D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 33E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 33E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 33E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 33E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 33A, 33C, 33D, and 33E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 33A, 33B, 33C, 33D, and 33E are provided by way of example only, and it is understood that the subject matter disclosed and claimed herein may be embodied or implemented in any similar communication system, whether presently defined or defined in the future.

FIG. 33F is a block diagram of an exemplary computing system 90 in which one or more apparatuses of the communications networks illustrated in FIGS. 33A, 33C, 33D and 33E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 33A, 33B, 33C, 33D, and 33E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which can be used to store the desired information and which can be accessed by a computing system.

The following is a list of acronyms relating to service level technologies that may appear in the above description. Unless otherwise specified, the acronyms used herein refer to the corresponding term listed below in Table 1.

TABLE 1

| | |
|---|---|
| 5G | 5^{th} Generation |
| 3GPP | 3^{rd} Generation Partnership Project |
| CE | Control Element |
| CN | Core Network |
| CPDCCH | Common PDCCH |
| C-RNTI | Cell Radio-Network Temporary Identifier |
| CRS | Cell-specific Reference Signal |
| DL | Downlink |
| eMBB | enhanced Mobile Broadband |
| eNB | Evolved Node B |
| FDD | Frequency Division Duplex |
| gNB: | g Node B, A RAN node which supports the NR |
| | as well as connectivity to NGC |
| ID | Identifier |
| IMT | International Mobile Telecommunications |
| IP | Internet Protocol |
| LTE | Long Term Evolution |
| MBSFN | Multicast-Broadcast Single Frequency Network |
| MAC | Medium Access Control |
| MAC CE | MAC Control Element |
| MIB | Master Information Block |
| MSA | Multi-Slot Allocation |
| MTC | Machine-Type Communications |
| mMTC | Massive Machine Type Communication |
| NGC | Next Generation Core network |
| NR | New Radio |
| PBCH | Physical Broadcast Channel |
| PDCCH | Physical Downlink Control Channel |
| PDSCH | Physical Downlink Shared Channel |
| PHY | Physical Layer |
| PH | Power Headroom |
| PL | Path Loss |
| PRACH | Physical Random Access Channel |
| PUCCH | Physical Uplink Control Channel |
| PUSCH | Physical Uplink Shared Channel |
| PHY | PHYsical for (physical layer or sublayer) |
| RACH | Random Access CHannel |
| RAN | Radio Access Network |
| RAT | Radio Access Technology |
| RNTI | Radio Network Temporary Identifier |
| RRC | Radio Resource Control |
| RSRP | Reference Signal Received Power |
| RSRQ | Reference Signal Received Quality |
| Rx | Receiver |
| SCell: | Secondary Cell |
| SCH | Shared Channel |
| SF | SubFrame |
| SFA | SubFrame Allocation |
| SFN | System Frame Number |
| SPID | Subscriber Profile ID |
| SRS | Sounding Reference Signal |
| SS | Synchronization Signal |
| SSS | Secondary Synchronization Signal |
| TDD | Time Division Duplex |
| TRP | Transmission and Reception Point |
| Tx | Transmitter |
| UE | User Equipment |
| UL | Uplink |
| URLLC | Ultra-Reliable and Low Latency Communications |
| WLAN | Wireless Local Area network |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. An apparatus comprising a processor, a memory, and communication circuitry, the apparatus further comprising computer-executable instructions stored in the memory of the apparatus which, when executed by the processor of the apparatus, cause the apparatus to:
select a first uplink carrier frequency based on a priority of the first carrier frequency;
determine a characteristic of the first uplink carrier frequency, wherein the characteristic of the first uplink carrier frequency is a path loss, a transmit power, a power headroom, a receive quality, or a receive power of the first uplink carrier frequency;
evaluate the characteristic of the first uplink carrier frequency;
if the characteristic of the first uplink carrier frequency meets a use criterion, utilize the first uplink carrier frequency for uplink operations;
if the characteristic of the first uplink carrier frequency fails to meet the use criterion, select a second uplink carrier frequency.

2. The apparatus of claim 1, wherein the apparatus is a user equipment operating in idle mode or an inactive mode.

3. The apparatus of claim 2, wherein:
the characteristic of the first uplink carrier frequency is a path loss of the first uplink carrier frequency; and
the use criterion is a maximum path loss.

4. The apparatus of claim 2, wherein the second uplink carrier frequency is selected at least in part on the basis of a path loss of the second carrier frequency.

5. The apparatus of claim 2, wherein:
the characteristic of the first uplink carrier frequency is a receive power of the first uplink carrier frequency; and
the use criterion is a minimum receive power.

6. The apparatus of claim 2, wherein the second uplink carrier frequency is selected at least in part on the basis of a receive power of the second carrier frequency.

7. The apparatus of claim 2, wherein:
the characteristic of the first uplink carrier frequency is a receive quality of the first uplink carrier frequency; and
the use criterion is a minimum receive quality.

8. The apparatus of claim 2, wherein the second uplink carrier frequency is selected at least in part on the basis of a receive quality of the second carrier frequency.

9. The apparatus of claim 2, wherein:
the characteristic of the first uplink carrier frequency is a Physical Random Access Channel (PRACH) transmit power of the first uplink carrier frequency; and
the use criterion is a minimum PRACH transmit power.

10. The apparatus of claim 2, wherein the second uplink carrier frequency is selected at least in part on the basis of a PRACH tansmit power of the second carrier frequency.

11. The apparatus of claim 2, wherein:
the characteristic of the first uplink carrier frequency is a power headroom of the first uplink carrier frequency; and
the use criterion is a minimum power headroom.

12. The apparatus of claim 2, wherein the second uplink carrier frequency is selected at least in part on the basis of a power headroom of the second carrier frequency.

13. The apparatus of claim 2, wherein the priority of the first uplink carrier frequency and a priority of the second uplink carrier frequency are the same.

14. An apparatus comprising a processor, a memory, and communication circuitry, the apparatus further comprising computer-executable instructions stored in the memory of the apparatus which, when executed by the processor of the apparatus, cause the apparatus to receive, in Radio Resource Control (RRC) broadcast signaling from a gNB, system information comprising a first New Radio (NR) resource configuration.

15. The apparatus of claim 14, wherein the instructions further cause the apparatus to establish an RRC connection with the gNB.

16. The apparatus of claim 15, wherein the instructions further cause the apparatus to receive, via RRC dedicated signaling, a second NR resource configuration.

17. The apparatus of claim 14, wherein the instructions further cause the apparatus to receive, via a Physical Downlink Control Channel (PDCCH), a second NR resource configuration.

18. The apparatus of claim 14, wherein the instructions further cause the apparatus to receive, from the gNB, a dynamic resource grant allocation.

19. The apparatus of claim 14, wherein the first NR resource configuration comprises a set of Multicast-Broadcast Single Frequency Network (MBSFN) subframes.

20. The apparatus of claim 19, wherein the first NR resource configuration further comprises a mini-slot pattern.
